(19) United States
(12) Patent Application Publication
(10) Pub. No.: US 2008/0198621 A1
(43) Pub. Date: Aug. 21, 2008

(54) Optical Sheet and Surface Light Source Device

(75) Inventors: Yasuhiro Tanoue, Shiga-ken (JP); Masayuki Shinohara, kyoto-fu (JP)

Correspondence Address: OSHA LIANG L.L.P., 1221 MCKINNEY STREET, SUITE 2800, HOUSTON, TX, 77010, US

(73) Assignee: OMRON CORPORATION, Kyoto-shi (JP)

(21) Appl. No.: 11/662,784

(22) PCT Filed: Sep. 9, 2005
(86) PCT No.: PCT/JP05/16635

§ 371 Date: Mar. 14, 2007

(30) Foreign Application Priority Data
Sep. 15, 2004 (JP) 2004-267728

(51) Int. Cl. F21V 7/04; G02B 27/10

(52) U.S. Cl. 362/606; 359/619

(57) ABSTRACT

A semi-permeable/reflective sheet (19) has a lower surface as a flag light incident surface (47) and a surface opposite to the light incident surface (47) where a light reflection area (43a) and a light transmittance area (43b) are provided. The light transmittance area (43b) is a flat surface parallel to the light incident surface (47). The light reflection area (43a) is formed by a convex pattern (42) having a cross section of a rectangular equilateral triangular shape. A part of light (41) coming from the light incident surface (47) to the light transmittance area (43b) transmits the semi-permeable/reflective sheet (19) and goes out of the surface opposite to the light incident surface (47). A part of the remaining light (41) incident from the light incident surface (47) is reflected twice by reflection walls (44, 45) forming the convex pattern (42). The light reflected by the reflection walls (44, 45) is emitted in parallel to the previous incident direction and in the reverse direction to the incident light.

### TECHNICAL FIELD

The present invention relates to an optical sheet and a surface light source device. Namely, the present invention relates to an optical sheet for transmitting partial light among incident light, and reflecting partial light. Further, the present invention relates to a surface light source device using this optical sheet.

### BACKGROUND ART

FIG. 1 is a schematic sectional view showing the structure of a both-face image display device 7 in a conventional example. In this both-face image display device 7, a convergent sheet 5 for converging diffusion light, and a first liquid crystal panel 4a of a large size are oppositely sequentially arranged on one face of a surface light source device 3 constructed by a light source 1 and a light guide plate 2. A semi-transmitting reflection sheet 6 and a second liquid crystal panel 4b of a small size are oppositely arranged on the other face of the surface light source device 3.

The semi-transmitting reflection sheet 6 used here reflects one portion of the incident light, and transmits the remaining light. For example, structures as shown in FIGS. 2(a), 2(b), 2(c) and 2(d) are conventionally known (patent literature 1).

FIG. 2(a) shows one conventional example of the semi-transmitting reflection sheet 6. A reflection film 10 for light reflection constructed by a metallic thin film and white paint is partially formed on one face of a transparent base material 8 of glass or plastic, etc. An area for forming the reflection film 10 among the semi-transmitting reflection sheet 6 becomes a light reflection area 13. An area for forming no reflection film 10 and exposing the transparent base material 8 becomes a light transmission area 14. Accordingly, when light is incident from the reflection film 10 side to the semi-transmitting reflection sheet 6, light reaching the light reflection area 13 among this incident light is reflected on the reflection film 10 and is returned in an incident direction. Further, light reaching the light transmission area 14 is transmitted through the transparent base material 8, and is emitted in the same direction as the incident direction from a face of the side opposed to an incident face.

FIG. 2(b) shows another conventional example of the semi-transmitting reflection sheet 6. A reflection film 10 for light reflection constructed by a metallic thin film, white paint, etc. is partially formed on one face of an opaque base material 8. An area for forming the reflection film 10 on the base material 8 becomes a light reflection area 13. Further, a through hole 9 is punched in an area for forming no reflection film 10 of the base material 8. An area for punching this through hole 9 becomes a light transmission area 14. Accordingly, light reaching the light reflection area 13 among light incident from an arranging side of this reflection film 10 to the semi-transmitting reflection sheet 6 is reflected on the reflection film 10, and is returned in an incident direction. Further, light reaching the light transmission area 14 is transmitted through the through hole 9, and is emitted in the same direction as the incident direction from a face of the side opposed to an incident face.

FIG. 2(c) shows still another conventional example of the semi-transmitting reflection sheet 6 in which a micro air bubble 11 is dispersed within a transparent base material 8. Light incident to this semi-transmitting reflection sheet 6 is refracted or totally reflected at an interface of the base material 8 and the air bubble 11 so that this light is scattered. One portion of the incident light is emitted from an incident face side, and partial light is emitted from a face of the side opposed to the incident face.

FIG. 2(d) shows still another conventional example of the semi-transmitting reflection sheet 6 in which this sheet 6 is formed by a base material 8 of milk white dispersing a white pigment 12 therein. Light incident to this semi-transmitting reflection sheet 6 is reflected on the white pigment 12, and one portion of the incident light is emitted from an incident face side. Further, partial light is emitted from a face of the side opposed to the incident face.

However, as shown in FIGS. 2(a) and 2(b), in the semi-transmitting reflection sheet 6 set to reflect partial light by using the reflection film 10 of a metallic thin film and white paint, light is absorbed by the reflection film 10 and utilization efficiency of the reflection light (reflection efficiency of light) gets worse. Further, an absorption ratio of the reflection light using the reflection film 10 depends on a wavelength. Accordingly, a problem exists in that it is difficult to manufacture the semi-transmitting reflection sheet 6 so as to obtain a predetermined desirable reflection ratio and the reflection ratio depending on no wavelength.

On the other hand, as shown in FIGS. 2(c) and 2(d), in a mass production process of the semi-transmitting reflection sheet 6 in which a micro air bubble 11 and a white pigment 12 are dispersed within a base material 8, it is difficult to constantly set the ratios of containing amounts of the air bubble 11 and the white pigment 12. Further, it is also not easy to uniformly distribute the air bubble 11 and the white pigment 12 over an entire face of the base material 8. Therefore, in such a conventional example, since the containing amounts of the air bubble 11 and the white pigment 12 are dispersed, it is difficult to manage quality such that reflectivity and transmittance become constant in the individual semi-transmitting reflection sheet 6. Further, when there are distribution irregularities in the air bubble 11 and the white pigment 12 within the base material 8, irregularities of reflectivity and transmittance are also generated in the semi-transmitting reflection sheet 6. Further, in these conventional examples, utilization efficiency of light is low since light perpendicularly incident is scattered in an unspecific direction.

Patent literature 1: JP-A-2004-87409

Patent literature 2: JP-A-2003-317520

Patent literature 3: JP-A-8-248421

Patent literature 4: Japanese Patent No. 3310023

### DISCLOSURE OF THE INVENTION

### Problems that the Invention is to Solve

The present invention is made in consideration of the above technical problems, and its object is to provide an optical sheet able to precisely control reflectivity and transmittance of light and excellent in utilization efficiency of light.

### Means for Solving the Problems

A first optical sheet in accordance with the present invention is an optical sheet in which plural convex patterns having at least two inclining reflection walls are mutually spaced and formed on a face opposed to a light incident face of a transparent substrate with one face as the light incident face; and one portion of light incident to the transparent substrate is totally reflected on each reflection wall of the convex pattern and is thereby emitted from the light incident face toward a direction parallel to an incident direction; and the remaining one portion of the light incident to the transparent substrate is transmitted through an area not forming the reflection wall and is thereby emitted from a face opposed to the light incident face.

In accordance with the first optical sheet in the present invention, light incident to the reflection wall of the convex pattern is reflected at least twice on the reflection wall and is thereby reflected toward the original incident direction. Further, light incident to a portion having no reflection wall is transmitted through the optical sheet and is emitted from the face of a side opposed to the light incident face. In this optical sheet, transmittance and/or reflectivity of the optical sheet can be set on the basis of a ratio of the area of a region (light reflecting area) forming the above reflection wall and the area of a region (transmitting area) not forming the above reflection wall. Accordingly, for example, this optical sheet can be used as a semi-transmitting reflection sheet.

In accordance with such a first optical sheet, light is totally reflected on the reflection wall of the convex pattern formed on the surface of the transparent substrate. Accordingly, no light is absorbed and scattered as in a conventional example utilizing a metallic thin film, etc. in the reflection of light, and a conventional example for dispersing air bubbles and a white pigment. Partial light can be reflected and partial light can be transmitted with high light utilization efficiency. Further, there is no fear that reflectivity depends on frequency of the incident light as in the conventional example using the metallic thin film. Further, in accordance with this optical sheet, for example, reflectivity or transmittance of the optical sheet can be changed in accordance with an area ratio (density) with respect to the entire region (reflecting area) for arranging the reflection wall, and an area ratio with respect to the entire region (transmitting area) for arranging no reflection wall. Accordingly, the reflectivity and transmittance of the optical sheet can be precisely controlled. Further, distributions of the reflectivity and transmittance of the optical sheet can be uniformed in accordance with a designing method of the arrangement (distribution) of the reflection wall.

In a certain embodiment mode of the first optical sheet in accordance with the present invention, a sectional shape of the convex pattern in a certain section perpendicular to the light incident face of the transparent substrate is an equilateral triangle in which two reflection faces constituting the convex pattern forms an angle of about 90 degrees. In such an embodiment mode, light approximately perpendicularly incident to the light incident face of the optical sheet is continuously totally reflected on the two reflection faces of the convex pattern, and is thereby reflected approximately in parallel with the incident light. In a normal use, it is not required that the direction of the reflection light is perfectly parallel to the direction of the incident light. Accordingly, it is sufficient to set the two reflection faces constituting the convex pattern to form an angle of about 90 degrees, and these two reflection faces may be also set to form angles increased and decreased by several degrees with respect to 90 degrees.

In another embodiment mode of the first optical sheet in accordance with the present invention, a sectional shape of the convex pattern in a certain section perpendicular to the light incident face of the transparent substrate is an isosceles trapezoidal shape having an inclination angle of the reflection wall of about 45 degrees. In the optical sheet in the present invention, the sectional shape of the convex pattern is set to the isosceles trapezoidal shape, and the reflection walls having an inclination angle of 45 degrees are separated. However, light approximately perpendicularly incident to the light incident face of the optical sheet and totally reflected on one reflection wall is advanced within the convex pattern, and is totally reflected on the other reflection wall, and is approximately reflected in parallel to the incident light. Further, in such an embodiment mode, the sectional shape of the convex pattern is the isosceles trapezoidal shape and the reflection wall is separated at both ends of the convex pattern. Accordingly, each reflection wall constituting the reflecting area is finely dispersed, and the reflection wall becomes inconspicuous. In particular, a dark point due to the reflection wall at a time seen from the light transmitting side, and a bright point due to the reflection wall at a time seen from the light incident side become inconspicuous, and characteristics of the optical sheet can be uniformed.

In still another embodiment mode of the first optical sheet in accordance with the present invention, a sectional shape of the convex pattern in a certain section perpendicular to the light incident face of the transparent substrate is a square shape in which the vertical angle of a vertex located in a farthest position from the light incident face is about 90 degrees, and the projection lengths of two sides nipping this vertex onto the light incident face are approximately equal. In accordance with such an embodiment mode, the incident light is totally reflected on two sides of the convex pattern nipping a vertex having a vertical angle of about 90 degrees so that light can be reflected toward a direction approximately parallel to the original incident direction. Further, in this embodiment mode, the projection lengths of the two sides nipping the vertex having a vertical angle of about 90 degrees onto the light incident face are approximately equal. Accordingly, it is possible to reduce a disadvantage in that light totally reflected on one side is not reflected on the other side, and is reflected in a slanting direction, and a disadvantage in that an area unused to reflect light reflected on one side is caused on the other side. Further, in accordance with this embodiment mode, the inclination of a third side except for the sides nipping the vertex having a vertical angle of about 90 degrees is suitably designed so that light slantingly incident to the incident face of the optical sheet is totally reflected on the third side, etc. and can be thereby emitted in a direction approximately perpendicular to the incident face. Thus, light utilization efficiency can be further improved. Since this convex pattern is a micro pattern, it is difficult to perfectly equally set the projection lengths of two sides by a manufacture error, and an error of about several ten % is allowed.

In still another embodiment mode of the first optical sheet in accordance with the present invention, a sectional shape of the convex pattern in a certain section perpendicular to the light incident face of the transparent substrate is a pentagonal shape of an about W-character shape hollow in its central portion such that each of the vertical angles of two vertexes projected toward a side far from the light incident face of the convex pattern is 90 degrees, and each of the projection lengths of two sides nipping these vertexes onto the light incident face is approximately equal. In accordance with such an embodiment mode, the incident light is totally reflected on two sides of the convex pattern nipping a vertex having a vertical angle of 90 degrees so that light can be reflected toward a direction approximately parallel to the original incident direction. Further, in this embodiment mode, the projection lengths of the two sides nipping the vertex having a vertical angle of 90 degrees onto the light incident face are approximately equal. Accordingly, it is possible to reduce a disadvantage in that light totally reflected on one side is not reflected on the other side, and is reflected in a slanting direction, and a disadvantage in that an area unused to reflect light reflected on one side is caused on the other side. Further, in accordance with this embodiment mode, a die for molding the convex pattern of a pentagonal shape in section has a concave portion of a W-groove shape in section approximately having corner portions having an angle of 90 degrees in two places. Accordingly, the concave portion of the die can be easily manufactured by changing an inclination by using a cutting tool of a rectangular shape and twice performing grinding.

A second optical sheet in accordance with the present invention is an optical sheet in which plural concave patterns having at least two inclining reflection walls are mutually spaced and formed on a face opposed to a light incident face of a transparent substrate with one face as the light incident face; and one portion of light incident to the transparent substrate is totally reflected on the reflection wall between the concave patterns and is thereby emitted from the light incident face toward a direction parallel to an incident direction; and the remaining one portion of the light incident to the transparent substrate is transmitted through an area not forming the reflection wall and is thereby emitted from a face opposed to the light incident face.

In accordance with the second optical sheet in the present invention, light incident to the reflection wall of the concave pattern is reflected at least twice between the reflection walls of the adjacent concave pattern and is thereby reflected toward the original incident direction. Further, light incident to a portion having no reflection wall is transmitted through the optical sheet and is emitted from the face of a side opposed to the light incident face. In this optical sheet, transmittance and/or reflectivity of the optical sheet can be set on the basis of a ratio of the area of a region (light reflecting area) forming the above reflection wall and the area of a region (transmitting area) not forming the above reflection wall. Accordingly, for example, this optical sheet can be used as a semi-transmitting reflection sheet.

In accordance with such a second optical sheet, light is totally reflected on the reflection wall of the concave pattern formed on the surface of the transparent substrate. Accordingly, no light is absorbed and scattered as in a conventional example utilizing a metallic thin film, etc. in the reflection of light, and a conventional example for dispersing air bubbles and a white pigment. Partial light can be reflected and partial light can be transmitted with high light utilization efficiency. Further, there is no fear that reflectivity depends on frequency of the incident light as in the conventional example using the metallic thin film. Further, in accordance with this optical sheet, for example, reflectivity or transmittance of the optical sheet can be changed in accordance with an area ratio (density) with respect to the entire region (reflecting area) for arranging the reflection wall, and an area ratio with respect to the entire region (transmitting area) for arranging no reflection wall. Accordingly, the reflectivity and transmittance of the optical sheet can be precisely controlled. Further, distributions of the reflectivity and transmittance of the optical sheet can be uniformed in accordance with a designing method of the arrangement (distribution) of the reflection wall.

In a certain embodiment mode of the second optical sheet in the present invention, a sectional shape of the concave pattern in a certain section perpendicular to the light incident face of the transparent substrate is a V-groove shape of an equilateral triangle in which two reflection walls constituting the concave pattern forms an angle of about 90 degrees. In such an embodiment mode, light approximately perpendicularly incident to the light incident face of the optical sheet is continuously totally reflected on each reflection face of the adjacent concave pattern and is thereby reflected approximately in parallel with the incident light. In a normal use, it is not required that the direction of the reflection light is perfectly parallel to the direction of the incident light. Accordingly, it is sufficient to set the two reflection faces constituting the concave pattern to form an angle of about 90 degrees, and these two reflection faces may be also set to form angles increased and decreased by several degrees with respect to 90 degrees.

In another embodiment mode of the second optical sheet in the present invention, a sectional shape of the concave pattern in a certain section perpendicular to the light incident face of the transparent substrate is a concave groove shape of an isosceles trapezoidal shape having an inclination angle of the reflection wall of about 45 degrees. In the optical sheet in the present invention, the reflection walls having an inclination angle of the adjacent concave pattern of 45 degrees are arranged. Accordingly, light approximately perpendicularly incident to the light incident face of the optical sheet and totally reflected on one reflection wall is totally reflected on the other reflection wall, and is approximately reflected in parallel to the incident light. Further, in such an embodiment mode, the sectional shape of the concave pattern is the isosceles trapezoidal shape and the reflection wall is separated at both ends of the concave pattern. Accordingly, each reflection wall constituting the reflecting area is finely dispersed, and the reflection wall becomes inconspicuous. In particular, a dark point due to the reflection wall at a time seen from the light transmitting side, and a bright point due to the reflection wall at a time seen from the light incident side become inconspicuous, and characteristics of the optical sheet can be uniformed.

A third optical sheet in the present invention is an optical sheet in which plural irregular patterns of concave and convex shapes having at least three inclining reflection walls are mutually spaced and formed on a face opposed to a light incident face of a transparent substrate with one face as the light incident face; and

one portion of light incident to the transparent substrate is totally reflected on the reflection wall between the irregular patterns and is thereby emitted from the light incident face toward a direction parallel to an incident direction; and the remaining one portion of the light incident to the transparent substrate is transmitted through an area not forming the reflection wall and is thereby emitted from a face opposed to the light incident face.

In accordance with the third optical sheet in the present invention, light incident to the reflection wall of the irregular pattern is reflected at least twice on the reflection wall of the irregular pattern and is thereby reflected toward the original incident direction. Further, light incident to a portion having no reflection wall is transmitted through the optical sheet and is emitted from the face of a side opposed to the light incident face. In this optical sheet, transmittance and/or reflectivity of the optical sheet can be set on the basis of a ratio of the area of a region (light reflecting area) forming the above reflection wall and the area of a region (transmitting area) not forming the above reflection wall. Accordingly, for example, this optical sheet can be used as a semi-transmitting reflection sheet.

In accordance with such a third optical sheet, light is totally reflected on the reflection wall of the irregular pattern formed on the surface of the transparent substrate. Accordingly, in principle, no light is absorbed and scattered as in a conventional example utilizing a metallic thin film, etc. in the reflection of light, and a conventional example for dispersing air bubbles and a white pigment. Partial light can be reflected and partial light can be transmitted with high light utilization efficiency. Further, there is no fear that reflectivity depends on frequency of the incident light as in the conventional example using the metallic thin film. Further, in accordance with this optical sheet, for example, reflectivity or transmittance of the optical sheet can be changed in accordance with an area ratio (density) with respect to the entire region (reflecting area) for arranging the reflection wall, and an area ratio with respect to the entire region (transmitting area) for arranging no reflection wall. Accordingly, the reflectivity and transmittance of the optical sheet can be precisely controlled. Further, distributions of the reflectivity and transmittance of the optical sheet can be uniformed in accordance with a designing method of the arrangement (distribution) of the reflection wall.

In still another embodiment mode of the first, second and third optical sheets in the present invention, a light diffusion face is formed in at least one portion of a face not forming the reflection wall among the light incident face of the transparent substrate and a face opposed to the light incident face. In accordance with such an embodiment mode, light incident to the optical sheet can be diffused by the light diffusion face. Hence, it is possible to make the optical sheet have the function of a diffusion sheet. Accordingly, it is not necessary to separately prepare the diffusion sheet even when the diffusion sheet is required.

A first surface light source device in the present invention is a surface light source device constructed by a light source, and a light guide plate for spreading light incident from the light source in a face shape and emitting this light from a light emitting face; and

the first, second or third optical sheet of the present invention is arranged on a light emitting face side of the light guide plate so as to direct its light incident face toward the light guide plate so that light is emitted on the light emitting face side of the light guide plate and a side opposed to the light emitting face.

In the first surface light source device of the present invention, one portion of light emitted from the light emitting face of the light guide plate is transmitted through the optical sheet. The remaining partial light is reflected on the optical sheet, and is then transmitted through the light guide plate and is emitted from a face of the side opposed to the light emitting face. As this result, light can be emitted onto the light emitting face of the light guide plate and the side opposed to the light emitting face, and the surface light source device of a both-face light emitting type can be obtained. Further, high light utilization efficiency can be achieved since the optical sheet of the present invention is used in this surface light source device. Further, there is no fear that reflectivity of the optical sheet depends on frequency of the incident light. Further, in accordance with this optical sheet, for example, reflectivity or transmittance of the optical sheet can be changed in accordance with an area ratio (density) with respect to the entire region (reflecting area) for arranging the reflection wall, and an area ratio with respect to the entire region (transmitting area) for arranging no reflection wall. Accordingly, the reflectivity and transmittance of the optical sheet can be precisely controlled.

A second surface light source device in the present invention is a surface light source device constructed by a light source, and a light guide plate for spreading light incident from the light source in a face shape and emitting this light from a light emitting face; and

a polarizing selection reflection sheet is arranged on a light emitting face side of the light guide plate, and the optical sheet of the first, second or third optical sheet of the present invention is arranged on a side opposed to the light emitting face of the light guide plate so as to direct its light incident face toward the light guide plate so that light is emitted on the light emitting face side of the light guide plate and the side opposed to the light emitting face.

In the second surface light source device of the present invention, light of one polarizing direction among light emitted from the light emitting face of the light guide plate is transmitted through the polarizing selection reflection sheet. Light of the other polarizing direction is reflected on the polarizing selection reflection sheet, and is transmitted through the light guide plate, and reaches the optical sheet. One portion of the light reaching the optical sheet is transmitted through the optical sheet. Further, the remaining light reaching the optical sheet is reflected on the optical sheet, and a polarizing state is changed at this time. The light reflected on the optical sheet is transmitted through the light guide plate, and reaches the polarizing selection reflection sheet. The light of one polarizing direction is transmitted through the polarizing selection reflection sheet, and the light of the other polarizing direction is reflected on the polarizing selection reflection sheet. As this result, light can be emitted onto the light emitting face of the light guide plate and the side opposed to the light emitting face, and the surface light source device of a both-face light emitting type can be obtained. Further, high light utilization efficiency can be achieved since the optical sheet of the present invention is used in this surface light source device. Further, there is no fear that reflectivity of the optical sheet depends on frequency of the incident light. Further, in accordance with this optical sheet, for example, reflectivity or transmittance of the optical sheet can be changed in accordance with an area ratio (density) with respect to the entire region (reflecting area) for arranging the reflection wall, and an area ratio with respect to the entire region (transmitting area) for arranging no reflection wall. Accordingly, the reflectivity and transmittance of the optical sheet can be precisely controlled.

A third surface light source device in the present invention is a surface light source device constructed by a light source, and a light guide plate for spreading light incident from the light source in a face shape and emitting this light from a light emitting face; and

a polarizing selection reflection sheet is arranged on a light emitting face side of the light guide plate, and the optical sheet of the present invention having a square or pentagonal convex pattern in section is arranged on a side opposed to the light emitting face of the light guide plate so as to direct its light incident face toward the light guide plate so that light is emitted on the light emitting face side of the light guide plate and the side opposed to the light emitting face; and

light emitted from a face opposed to the light emitting face of the light guide plate is reflected or refracted by the convex pattern of the optical sheet so that this light is deflected in the same direction as light transmitted through an area forming no convex pattern of the optical sheet, and is emitted from the face opposed to the light incident face of the optical sheet.

In the third surface light source device of the present invention, light of one polarizing direction among light emitted from the light emitting face of the light guide plate is transmitted through the polarizing selection reflection sheet. Light of the other polarizing direction is reflected on the polarizing selection reflection sheet, and is transmitted through the light guide plate, and reaches the optical sheet. One portion of the light reaching the optical sheet is transmitted through the optical sheet. Further, the remaining light reaching the optical sheet is reflected on the optical sheet, and a polarizing state is changed at this time. The light reflected on the optical sheet is transmitted through the light guide plate, and reaches the polarizing selection reflection sheet. The light of one polarizing direction is transmitted through the polarizing selection reflection sheet, and the light of the other polarizing direction is reflected on the polarizing selection reflection sheet. As this result, light can be emitted onto the light emitting face of the light guide plate and the side opposed to the light emitting face, and the surface light source device of a both-face light emitting type can be obtained. Further, light emitted from the face opposed to the light emitting face of the light guide plate is reflected or refracted by the convex pattern of the optical sheet so that this light is deflected in the same direction as light transmitted through an area forming no convex pattern of the optical sheet, and is emitted from the face opposed to the light incident face of the optical sheet. Accordingly, utilization efficiency of light can be further improved.

In an embodiment mode of the second or third surface light source device of the present invention, in the surface light source device in which the polarizing selection reflection sheet is arranged on the light emitting face side of the light guide plate and the optical sheet is arranged on the face of its opposite side, a convex, concave or irregular pattern of the optical sheet is formed in a straight line shape seen from the light incident face side of the optical sheet, and a direction for extending the convex, concave or irregular pattern in the straight line shape and a polarizing axis direction of the polarizing selection reflection sheet form an angle of about 45 degrees. In accordance with such an embodiment mode, light is emitted from the light guide plate and is reflected on the polarizing selection reflection sheet. Thereafter, when light is transmitted through the light guide plate and linearly polarized light of a certain polarizing direction reaches the optical sheet, the polarizing direction of light reflected on the optical sheet can be rotated 90 degrees with respect to the polarizing direction of the incident linearly polarized light. Accordingly, the polarizing direction of the light reflected on the optical sheet becomes parallel to the polarizing direction of the polarizing selection reflection sheet, and this light is not reflected on the polarizing selection reflection sheet but is transmitted through the polarizing selection reflection sheet. Accordingly, it is possible to reduce the number of reflection times of light between the polarizing selection reflection sheet and the optical sheet, and smoothly take-out this light.

The constructional elements of the present invention explained above can be arbitrarily combined as much as possible.

### BRIEF DESCRIPTION OF THE DRAWINGS

FIG. 1 is a schematic side view of a conventional both-face image display device.

Each of FIGS. 2(a), 2(b), 2(c) and 2(d) is a cross-sectional view of a conventional semi-transmitting reflection sheet.

FIG. 3 is an exploded perspective view showing the structure of a both-face image display device in accordance with embodiment 1 of the present invention.

FIG. 4 is a cross-sectional view showing the structure of a light source used in embodiment 1.

FIG. 5 is a rear face view of a light guide plate used in embodiment 1.

FIG. 6 is a view showing a polarizing pattern arranged on a lower face of the above light guide plate.

FIG. 7(a) is a perspective view showing the contour of one polarizing pattern, and FIGS. 7(b) and 7(c) are views showing a sectional shape of the polarizing pattern and its action.

FIG. 8 is a plan view of a semi-transmitting reflection sheet used in embodiment 1.

FIG. 9 is a cross-sectional view enlarging and showing one portion of the above semi-transmitting reflection sheet.

FIGS. 10(a), 10(b) and 10(c) are views for explaining a manufacturing method of the semi-transmitting reflection sheet.

FIG. 11 is a view for explaining the behavior of light within the light guide plate in the both-face image display device of embodiment 1.

FIG. 12 is a view for explaining the behavior of light emitted from the light guide plate in the both-face image display device of embodiment 1.

FIG. 13 is a view for explaining a method for distributing light to each azimuth within the light guide plate.

FIG. 14 is an enlarged view showing a trailing area of the base in a convex pattern of the semi-transmitting reflection sheet.

FIG. 15 is a plan view of the semi-transmitting reflection sheet showing the convex pattern formed in an arc shape.

FIG. 16(a) is a plan view of a semi-transmitting reflection sheet used in embodiment 2, and each of FIGS. 16(b), 16(c) and 16(d) is a perspective view showing the shape of a convex pattern formed in the semi-transmitting reflection sheet of FIG. 16(a).

FIG. 17(a) is a view for explaining a different sectional shape of the convex pattern, and FIG. 17(b) is a cross-sectional view showing an irregular pattern constituting a light reflecting area.

FIG. 18 is a partial enlarged sectional view showing a semi-transmitting reflection sheet used in embodiment 3.

FIG. 19 is a partial enlarged sectional view of a semi-transmitting reflection sheet used in embodiment 4.

FIG. 20 is a partial enlarged sectional view of a semi-transmitting reflection sheet used in embodiment 5.

FIG. 21 is an exploded perspective view showing the structure of a both-face image display device in accordance with embodiment 6 of the present invention.

FIG. 22 is a view for explaining the behavior of light in the both-face image display device of embodiment 6.

FIG. 23 is a view for explaining the behavior of light in a both-face image display device different from the above both-face image display device.

FIG. 24 is a partial enlarged sectional view of a semi-transmitting reflection sheet used in embodiment 7.

FIG. 25 is a graph showing the relation of an emitting direction of leak light from the light guide plate and light intensity.

FIG. 26 is a view for explaining a reason for equally setting projection lengths AE and EF in the semi-transmitting reflection sheet of embodiment 7.

FIG. 27 is a partial enlarged sectional view of a semi-transmitting reflection sheet used in embodiment 8.

FIG. 28(a) is a view for explaining a processing method of an upper die used in manufacture of the semi-transmitting reflection sheet used in embodiment 7, and FIG. 28(b) is a view for explaining a processing method of an upper die used in manufacture of the semi-transmitting reflection sheet used in embodiment 8.

FIG. 29 is a partial enlarged sectional view of a semi-transmitting reflection sheet in accordance with embodiment 9.

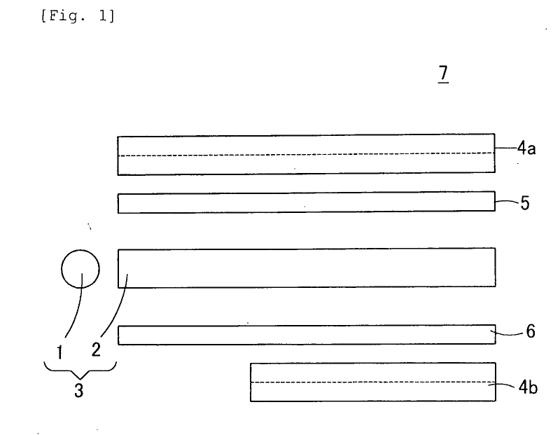

### DESCRIPTION OF THE REFERENCE NUMERALS AND SIGNS

15 both-face image display device
16, 18 liquid crystal panel
17 surface light source device
19 semi-transmitting reflection sheet
20 light source
21 light guide plate
42 convex pattern
42′ irregular pattern
42″ concave pattern
43a light reflecting area
43b light transmitting area
44, 45 reflecting wall
47 light incident face
52 scattering face
53 polarizing selection reflection sheet

### BEST MODE FOR CARRYING OUT THE INVENTION

Embodiments of the present invention will next be explained in detail in accordance with the drawings. However, the present invention is naturally not limited to the embodiments explained below.

### EMBODIMENT 1

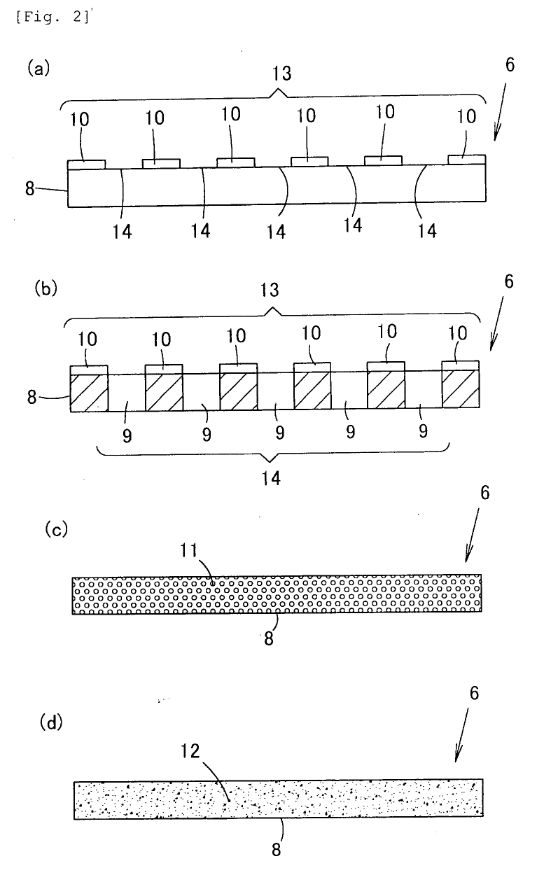

FIG. 3 is an exploded perspective view showing the structure of a both-face image display device 15 in accordance with embodiment 1 of the present invention. This both-face image display device 15 is constructed from a first liquid crystal panel 16 constituting one display face, a second liquid crystal panel 18 constituting the other display face, a surface light source device 17 and a semi-transmitting reflection sheet (optical sheet) 19. The first liquid crystal panel 16 is arranged so as to be opposed to one face of the semi-transmitting reflection sheet 19 (the face of an arranging side of the liquid crystal panel 16 is set to an upper face side in accordance with FIG. 3). The surface light source device 17 is arranged so as to be opposed to the other face of the semi-transmitting reflection sheet 19 (the face of an arranging side of the surface light source device 17 is set to a lower face side in accordance with FIG. 3). The second liquid crystal panel 18 is arranged so as to be opposed to a face of the opposite side of a face opposed to the semi-transmitting reflection sheet 19 of the surface light source device 17. Further, the surface light source device 17 is constructed by a small light source 20 (also called a point light source in a certain case) and a light guide plate 21.

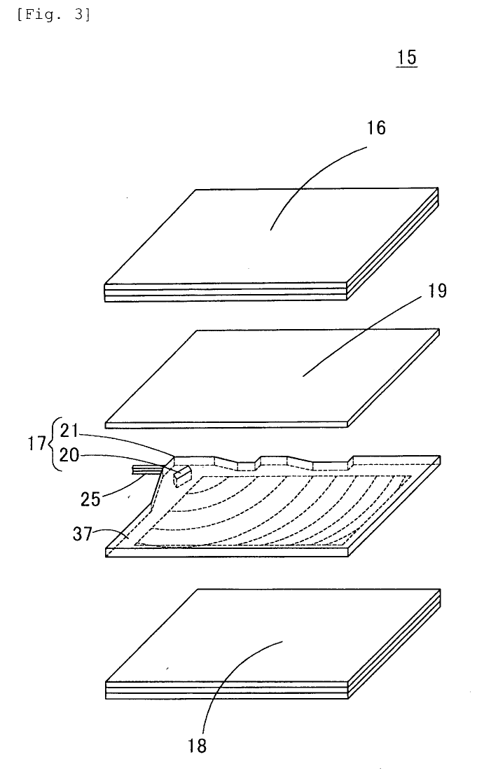

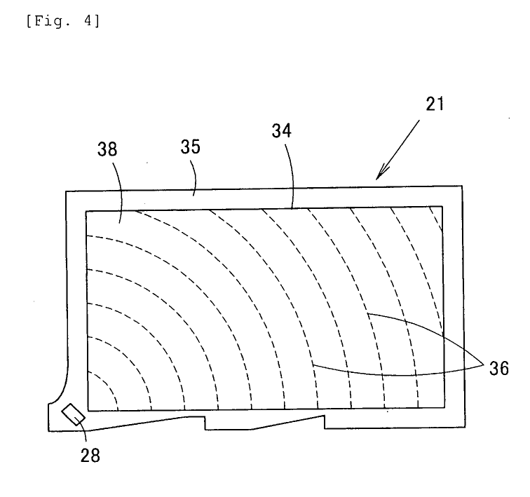

FIG. 4 is a cross-sectional view showing the structure of the above light source 20. The light source 20 is a small light source in comparison with the width of the light guide plate 21. The light source 20 is constructed by sealing a light emitting diode (LED) chip 22 within transparent resin 23, and covering a face except for its front face with white transparent resin 24. This light source 20 is mounted onto a film wiring substrate 25, and is fixed to the film wiring substrate 25 by solder 26. Further, the film wiring substrate 25 is fixed to a reinforcing plate 27 constructed by glass epoxy resin. A hole 28 for inserting the light source 20 passes through a corner portion of the light guide plate 21 in a vertical direction. A positioning pin 29 is projected on a lower face of the light guide plate 21 near the hole 28. On the other hand, through holes 30, 31 for inserting the positioning pin 29 are bored in the film wiring substrate (FPC) 25 and the reinforcing plate 27.

When the light source 20 is attached to the light guide plate 21, the lower face of the light guide plate 21 is coated with an ultraviolet hardening type adhesive 32 in the circumference of a base portion of the positioning pin 29. After the positioning pin 29 is inserted into the film wiring substrate 25 and the through holes 30, 31 of the reinforcing plate 27, a thickness direction center of the light guide plate 21 and a light emission center of the light source 20 are positioned while being monitored by a CCD camera, etc. After these centers are completely positioned, the ultraviolet hardening type adhesive 32 is hardened by irradiating an ultraviolet ray. Thus, the light source 20 is firmly fixed to the light guide plate 21, and the positioning pin 29 is thermally caulked.

At this time, as shown in FIG. 4, the light emission center of the light source 20 may be also positioned by setting a projection 33 arranged at the thickness direction center of an inner face of the hole 28 to a mark. An arranging position of the projection 33 may be located on a rear face side of the light source 20 and may be also located on its front face side, and may be also located on both the rear face side and the front face side.

A glass epoxy wiring substrate and a lead frame may be also used instead of the film wiring substrate 25. Further, when two light emitting diode chips or more are used, a point light source may be also formed by collecting the plural light emitting diode chips in one place. Further, the light source 20 may be also formed by directly insert-molding the light emitting diode chip within the light guide plate 21, and may be also arranged in the exterior of the light guide plate 21 (in a position opposed to an outer circumferential face of the light guide plate 21). Further, plural point light sources are arranged in proximity to each other, and may be also set to the light source 20.

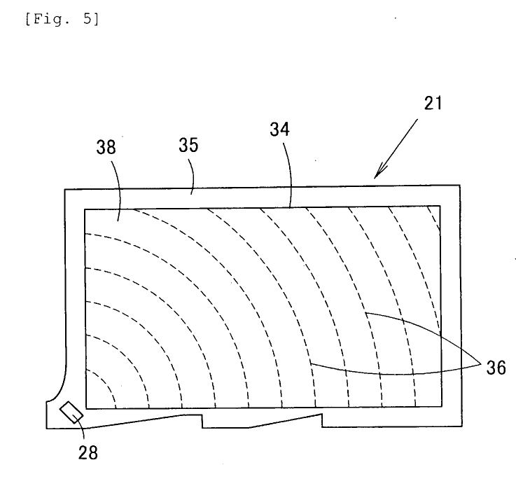

FIG. 5 is a bottom view of the above light guide plate 21. The above light guide plate 21 is approximately molded in a rectangular flat plate shape by transparent resin of a high refractive index such as polycarbonate resin, acrylic resin, methacryl resin, etc., and glass. A surface light emitting area 34 of a rectangular shape as a substantial surface light source is formed on a lower face of the light guide plate 21. A non-light emitting area 35 is formed in a frame shape around the surface light emitting area 34. The hole 28 for storing the light source 20 is opened to the non-light emitting area 35 at the end of a short side of the light guide plate 21. An optical element constructed by a lens, a prism, a diffuser, etc. is formed on a light incident face (an inner circumferential face of the hole 28) of the light guide plate 21 to control an orientation pattern of light incident from the light source 20 into the light guide plate 21.

A pattern face 38 having many micro deflecting patterns 36 is formed in the surface light emitting area 34 of the lower face of the light guide plate 21. Namely, the surface light emitting area 34 of the light guide plate 21 is a forming area of the deflecting pattern 36. FIG. 6 is a plan view in which the arrangement of the deflecting pattern 36 formed in the surface light emitting area 34 of the lower face of the light guide plate 21 is seen from the upper side. The deflecting pattern 36 is discretely spaced along a circular circumference with the light source 20 as a center, and is arranged in a concentric circle shape. The interval of each deflecting pattern 36 is comparatively wide on a side close to the light source 20, and is gradually shortened as the deflecting pattern 36 is separated from the light source 20. In other words, a pattern density of each deflecting pattern 36 is comparatively small on the side close to the light source 20, and is gradually increased as the deflecting pattern 36 is separated from the light source 20. Thus, brightness on the upper face (hereinafter called a light emitting face 37) of the light guide plate 21 is uniformed.

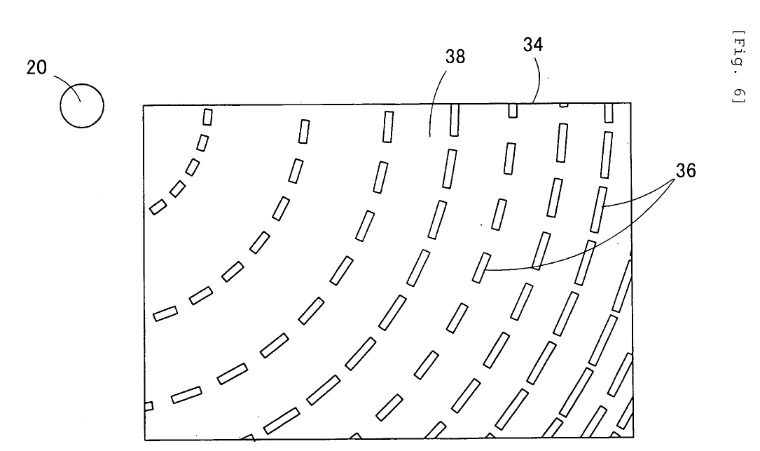

FIG. 7(a) is a perspective view showing the contour of the deflecting pattern 36. The deflecting pattern 36 is formed by concavely arranging the lower face of the light guide plate 21 in a triangular groove shape. The deflecting pattern 36 has a deflection inclination face 39 directed to the light source 20 side, and a re-incident face 40 directed to the side distant from the light source 20. FIGS. 7(b) and 7(c) show a section of the deflecting pattern 36. As shown in FIG. 7(b), if an inclination angle of the deflection inclination face 39 is set to β, the inclination angle β is e.g., about 50°, and an inclination angle γ of the re-incident face 40 is greater than the inclination angle β of the deflection inclination face 39. Light 41 incident to the deflection inclination face 39 is totally reflected on the deflection inclination face 39, and is approximately perpendicularly incident to the upper face of the light guide plate 21, and is approximately perpendicularly emitted from the light emitting face 37 of the light guide plate 21. Further, as shown in FIG. 7(c), one portion of light 41 leaked from the deflection inclination face 39 of the deflecting pattern 36 to the exterior of the light guide plate 21 is again incident from the re-incident face 40 into the light guide plate 21, and is reutilized.

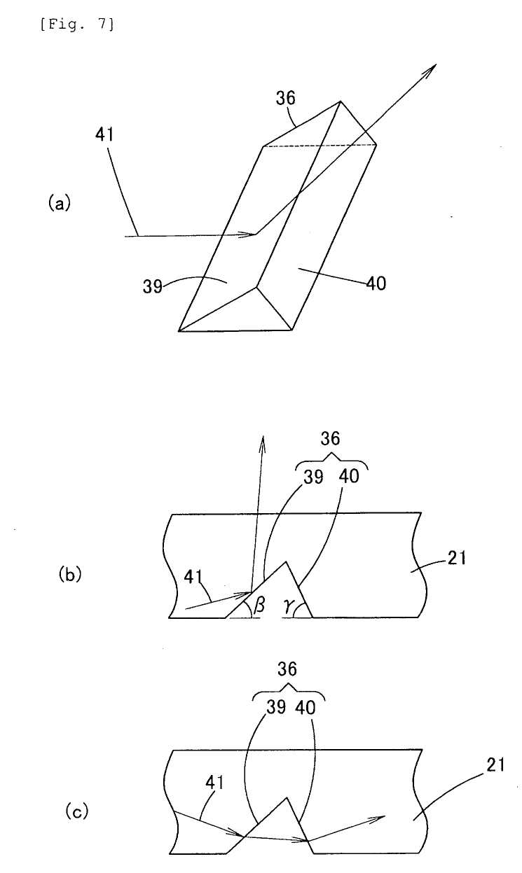

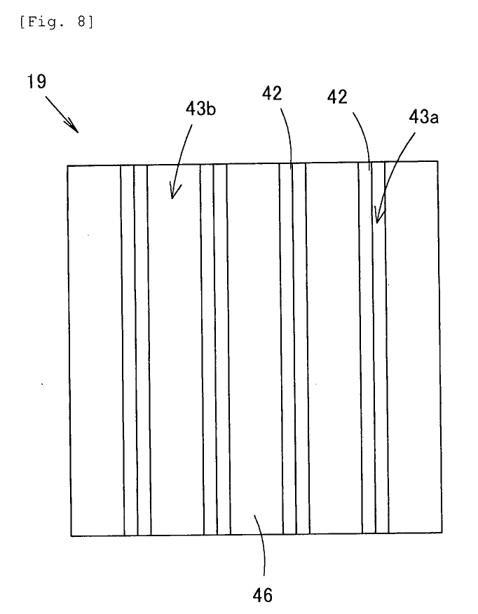

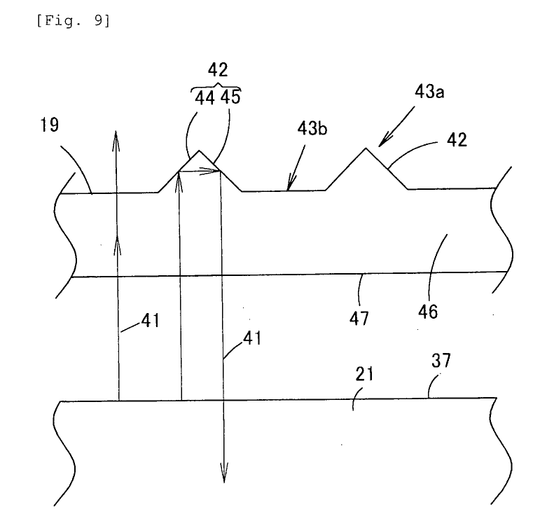

FIG. 8 is a plan view typically showing the semi-transmitting reflection sheet 19. FIG. 9 is an enlarged sectional view showing one portion of the semi-transmitting reflection sheet 19. The semi-transmitting reflection sheet 19 is formed by a transparent sheet 46 having a flat plate shape and constructed by transparent resin and transparent glass. A light incident face 47 of the semi-transmitting reflection sheet 19 is set to a flat face, and a light reflecting area 43a and a light transmitting area 43b are alternately formed on a face opposed to the light incident face 47. For example, polycarbonate resin, acrylic resin, polyolefin resin, PET (polyethylene terephthalate) resin, etc. can be used as transparent resin for molding the transparent sheet 46. As shown in FIG. 8, convex patterns 42 having plural stripe shapes are spaced at a constant interval and are formed in parallel with each other in the light reflecting area 43a of the semi-transmitting reflection sheet 19. In FIG. 8, for convenience of illustration, several convex patterns 42 are greatly drawn, but many convex patterns 42 having micro widths of several μm to several ten μm are really formed.

As shown in FIG. 9, one convex pattern 42 is constructed from reflection walls 44, 45 of two faces. The reflection walls 44, 45 are respectively inclined in opposite directions at an inclination angle of 45° with respect to the light transmitting area 43b. The reflection wall 44 and the reflection wall 45 form an angle of about 90° in a section perpendicular to a longitudinal direction of the convex pattern 42 and perpendicular to the light transmitting area 43b. The section of the convex pattern 42 is formed in the shape of a right-angled equilateral triangle. Further, as shown in FIG. 9, the light transmitting area 43b is formed by a flat plane parallel to the lower face (light incident face) of the semi-transmitting reflection sheet 19.

This semi-transmitting reflection sheet 19 is operated as explained next. Light 41 approximately perpendicularly emitted from the light emitting face 37 of the light guide plate 21 is approximately perpendicularly incident from the lower face of the semi-transmitting reflection sheet 19 into the semi-transmitting reflection sheet 19, and reaches the light reflecting area 43a and the light transmitting area 43b. Light 41 reaching the light transmitting area 43b is transmitted through the light transmitting area 43b, and is approximately perpendicularly emitted from the upper face of the semi-transmitting reflection sheet 19. On the other hand, light 41 reaching the light reflecting area 43a is totally reflected twice on the reflection walls 44 and 45, and is approximately perpendicularly emitted from the lower face of the semi-transmitting reflection sheet 19.

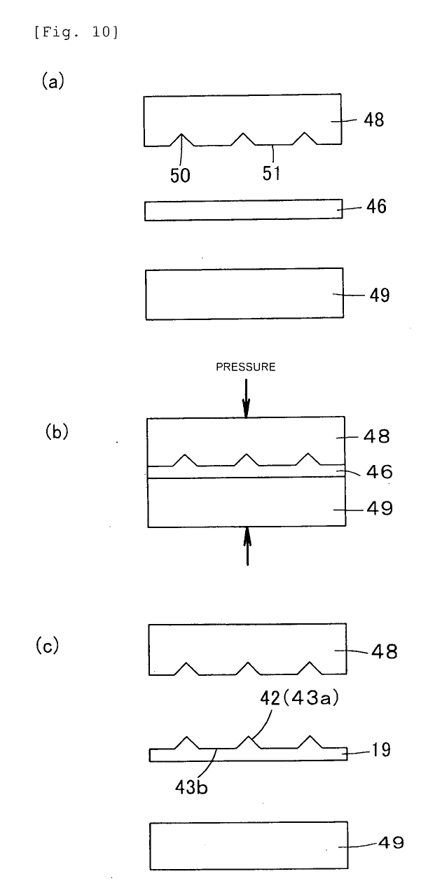

Next, one example of a manufacturing method of the semi-transmitting reflection sheet 19 will be explained by FIGS. 10(a) to 10(c). A transparent sheet 46 having a flat surface and constructed by transparent thermoplastic resin is used to mold the semi-transmitting reflection sheet 19. A molding die for molding the semi-transmitting reflection sheet 19 is constructed by an upper die 48 and a lower die 49. The surface of the lower die 49 is flatly formed. A concave stripe 50 for molding the convex pattern 42 of the semi-transmitting reflection sheet 19 and formed in a right-angled triangle shape in section, and a flat face 51 for forming the light transmitting area 43b of the semi-transmitting reflection sheet 19 are formed on a lower face of the upper die 48.

When the semi-transmitting reflection sheet 19 is molded, as shown in FIG. 10(a), the transparent sheet 46 is flatly arranged on the lower die 49. Next, as shown in FIG. 10(b), the transparent sheet 46 placed on the lower die 49 is pressed by the upper die 48, and the transparent sheet 46 is pressurized by the upper die 48 and the lower die 49 while heat is applied to the transparent sheet 46. Thus, as shown in FIG. 10(c), the concave stripe 50 formed in the upper die 48 is transferred to the transparent sheet 46, and the light reflecting area 43a (convex pattern 42) and the light transmitting area 43b are formed on the surface of the transparent sheet 46, and the semi-transmitting reflection sheet 19 is obtained.

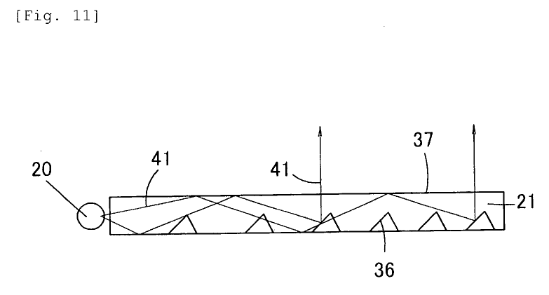

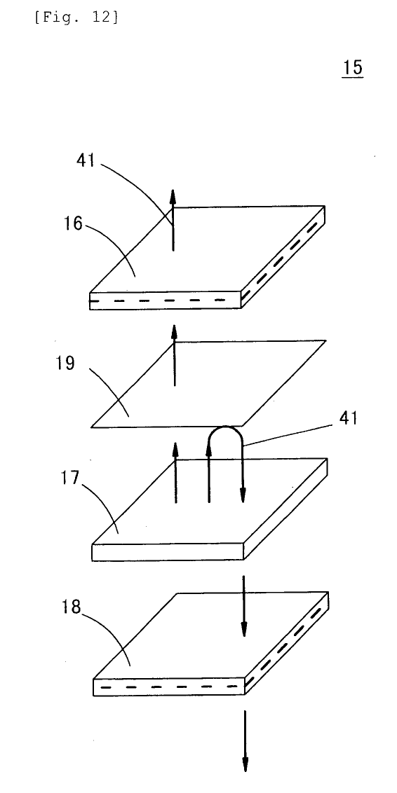

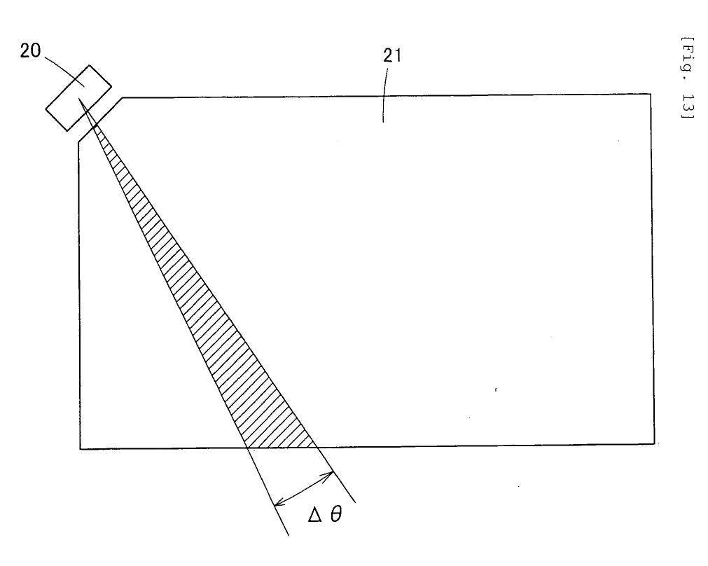

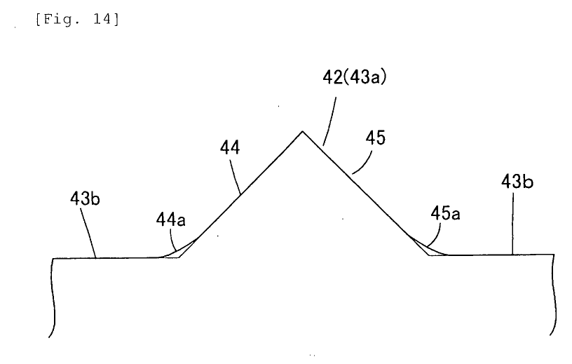

Next, the behavior of light in this both-face image display device 15 will be explained by FIGS. 11 and 12. The behavior of light in this surface light source device 17 will be explained by FIGS. 11 and 12. FIG. 11 is a view showing the behavior of light within the light guide plate 21. FIG. 12 is a view showing the behavior of light emitted from the light guide plate 21. As shown in FIG. 11, light 41 emitted from the light source 20 is incident from the light incident face into the light guide plate 21. Light 41 incident from the light incident face to the light guide plate 21 is spread and advanced in a radiating shape within the light guide plate 21. However, at this time, it is desirable to design an optical element such as a lens, a prism, a diffuser, etc. arranged on the light incident face such that the amount of light of each azimuth of light 41 spread within the light guide plate 21 is proportional to the area of the light guide plate 21 at each azimuth. Concretely, as shown in FIG. 13, it is desirable that the amount of light emitted within the range of a spread Δθ at an arbitrary azimuth of the light guide plate 21 is proportional to the area of the light guide plate (the area of a region shown by performing hatching in FIG. 13) included in this range Δθ. Thus, a brightness distribution of the surface light source device 17 at each azimuth can be uniformed.

As shown in FIG. 11, light 41 incident into the light guide plate 21 is advanced in a direction distant from the light source 20 within the light guide plate 21 while this light 41 is totally reflected on the upper face and the lower face of the light guide plate 21. Light 41 incident to the lower face of the light guide plate 21 is reflected on the deflecting pattern 36 formed in a triangular shape in section, and is transmitted through the light emitting face 37, and is emitted approximately perpendicularly to the light emitting face 37. As mentioned above, each deflecting pattern 36 is arranged such that its length direction is orthogonal to a direction for connecting the light source 20 and each deflecting pattern 36. Therefore, even when light 41 propagated within the light guide plate 21 is diffused by the deflecting pattern 36, its light 41 is diffused within a plane perpendicular to the light emitting face 37 and including the direction for connecting the light source 20 and the deflecting pattern 36. However, this light 41 is not diffused, but is straightly advanced within the plane parallel to the light emitting face 37.

Thus, as shown in FIG. 12, light approximately perpendicularly emitted from the light emitting face 37 of the light guide plate 21 is incident to the semi-transmitting reflection sheet 19. Light reaching the light transmitting area 43b among the light incident to the semi-transmitting reflection sheet 19 is transmitted through the semi-transmitting reflection sheet 19. Light reaching the light reflecting area 43a is totally reflected on the convex pattern 42. The light transmitted through the light transmitting area 43b of the semi-transmitting reflection sheet 19 is transmitted through the liquid crystal panel 16, and generates an image of the liquid crystal panel 16. Further, the light reflected on the light reflecting area 43a of the semi-transmitting reflection sheet 19 is transmitted through the light guide plate 21 as it is, and is further transmitted through the liquid crystal panel 18 and generates an image of the liquid crystal panel 18.

In accordance with the both-face image display device 15 of embodiment 1, two liquid crystal panels 16, 18 can be simultaneously illuminated by one surface light source device 17. Accordingly, the both-face image display device 15 can be thinly made, and electric power can be saved. Further, since no light emitted from the surface light source device 17 is absorbed in the light reflecting area 43a of the semi-transmitting reflection sheet 19, light emitted from the light source 20 can be almost utilized without loss, and utilization efficiency of light is excellent.

Further, since the patterns of the light reflecting area 43a and the light transmitting area 43b formed in the semi-transmitting reflection sheet 19 are formed at a micro size from several μm to several ten μm, the light reflecting area 43a and the light transmitting area 43b can be approximately uniformly arranged over the entire face of the semi-transmitting reflection sheet 19. Accordingly, light is uniformly reflected or transmitted on the entire face of the semi-transmitting reflection sheet 19.

In the semi-transmitting reflection sheet 19 of the present invention, in general, if a projection area to the light incident face of the reflecting wall is set to σ and the light transmitting area is set to σ in area, the reflectivity of the semi-transmitting reflection sheet 19 is determined by σ/(σ+ε) and its transmittance is determined as ε/(σ+ε). In particular, in this embodiment for forming the convex pattern 42 in a right-angled equilateral triangle shape in section, the projection area of the convex pattern 42 is set to σ, and the area of a flat region between the convex patterns 42 is set to ε, and reflectivity and transmittance can be determined by the above formula.

Further, the reflectivity and transmittance of the semi-transmitting reflection sheet 19 can be arbitrarily set within a range for forming the relation of

0<σ/(σ+ε)<1

or

0<ε/(σ+ε)<1.

Thus, it is possible to set a ratio for illuminating the liquid crystal panels 16, 18 by light emitted from the light guide plate 21 in accordance with necessity.

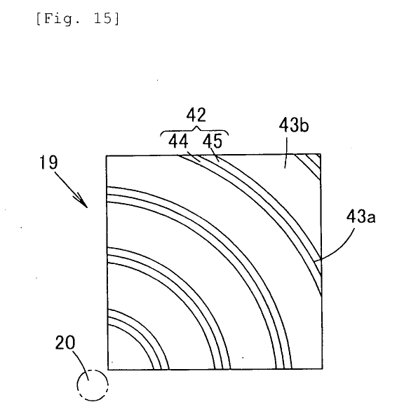

However, in a manufacturing process of the semi-transmitting reflection sheet 19, as shown in FIG. 14, areas 44a, 45a (hereinafter called base portions 44a, 45a) trailing the base in the reflection walls 44, 45 are formed in the light reflecting area 43a, and there is a case for slightly widening the light reflecting area 43a in comparison with a design value. Therefore, when the convex pattern 42 is formed in a triangular shape in section, it is desirable to set the ratio σ/(σ+ε) of the projection area σ of the light reflecting area 43a to 0.95 or less so as not to remove the light transmitting area 43b. Namely, it is desirable to set the reflectivity to 95% or less.

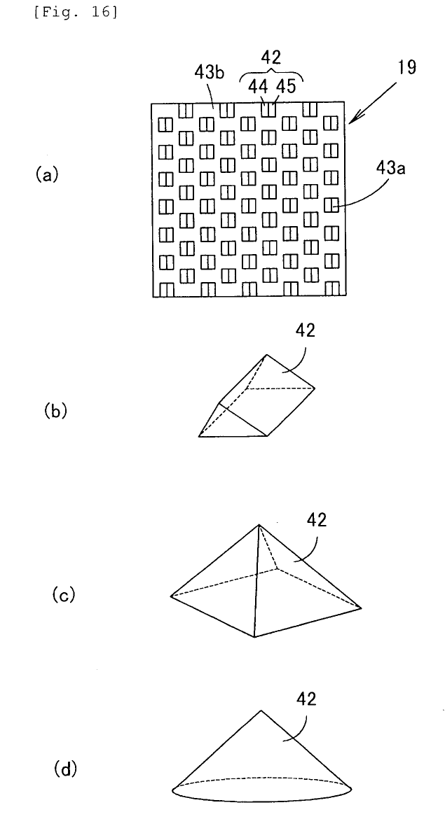

Further, in the arrangement of the light reflecting area 43a and the light transmitting area 43b formed on the upper face of the semi-transmitting reflection sheet 19, as shown in FIG. 15, the light reflecting area 43a and the light transmitting area 43b may be also arranged in a concentric circle shape with the light source 20 as a center when the light source 20 is a point light source.

### EMBODIMENT 2

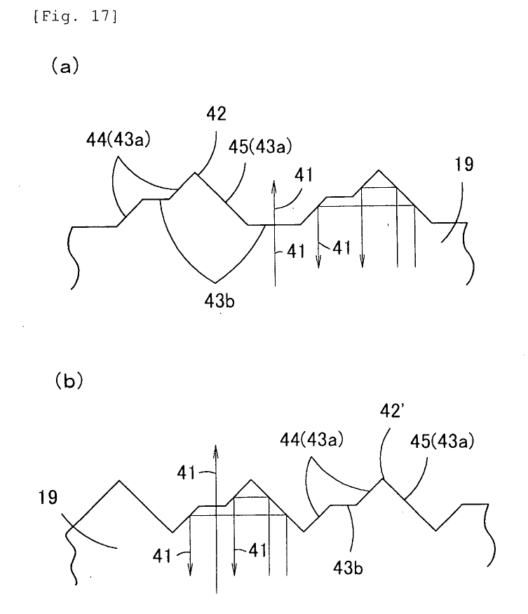

In embodiment 2 of the present invention, the structure of the semi-transmitting reflection sheet 19 in embodiment 1 is changed. FIG. 16 shows a top view of the semi-transmitting reflection sheet 19 in embodiment 2. In the semi-transmitting reflection sheet 19 of this embodiment, as shown in FIG. 16(a) the light reflecting area 43a formed in a convex shape on the upper face of a transparent sheet 46 is divided into small areas, and the convex pattern 42 is discretely arranged. Thus, the convex pattern 42 is set to be inconspicuous in comparison with the semi-transmitting reflection sheet 19 shown in embodiment 1. Further, no moire is easily generated between the semi-transmitting reflection sheet 19 and the liquid crystal panel 16.

The shape of the convex pattern 42 formed on the upper face of the semi-transmitting reflection sheet 19 may be set to a triangular shape as shown in FIG. 6(b), and may be also set to a pyramidal shape as shown in FIG. 16(c), and may be also set to a conical shape as shown in FIG. 16(d).

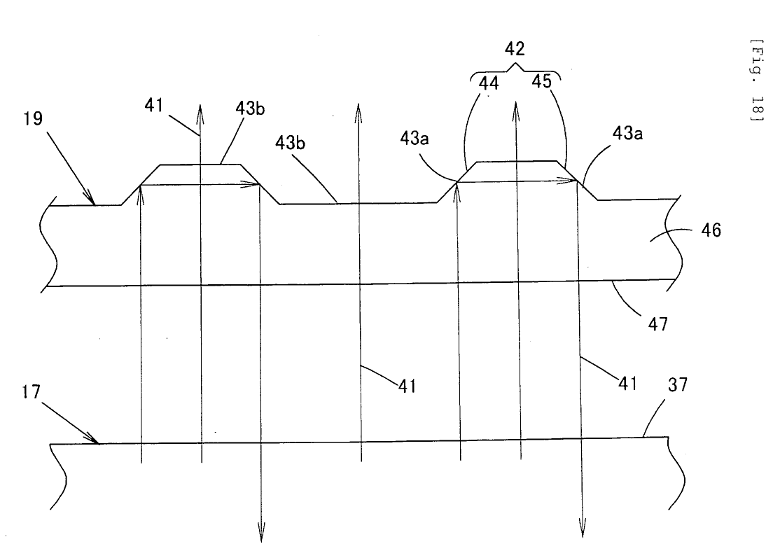

The convex pattern 42 having a reflection wall of three faces or more is not limited to only the pattern as shown in FIG. 16, but also includes the convex pattern 42 (e.g., a pattern formed in a straight line shape along the longitudinal direction) having a section as shown in FIG. 17(a). In FIG. 17(a), the convex pattern 42 is mutually spaced and arranged (claim 1). However, in a mode as shown in FIG. 17(b) in which such a pattern is arranged not to be spaced, an irregular pattern 42′ is mutually spaced and arranged (claim 9). The pattern as shown in FIG. 17(a) can be naturally also considered as a pattern in which the irregular pattern 42′ is mutually spaced and arranged.

### EMBODIMENT 3

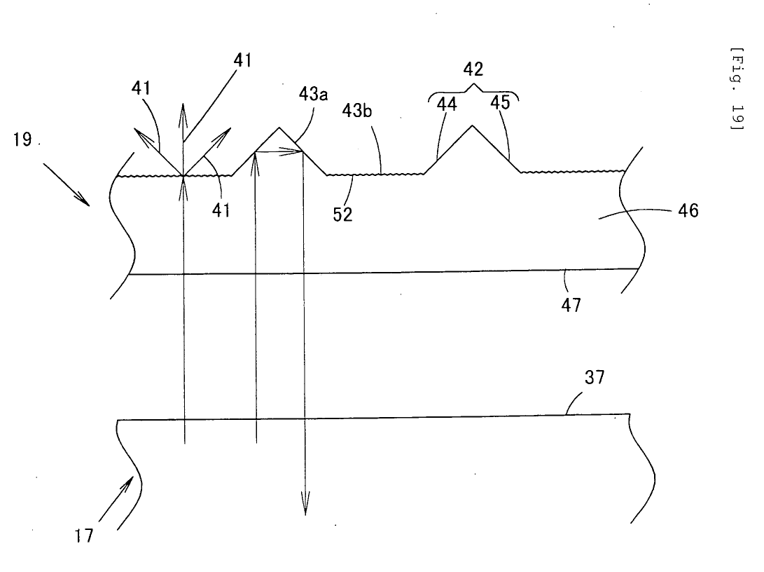

In embodiment 3 of the present invention, the structure of the semi-transmitting reflection sheet 19 in embodiment 1 is changed. FIG. 18 is a cross-sectional view of the semi-transmitting reflection sheet 19 in embodiment 3. The semi-transmitting reflection sheet 19 is molded in a flat plate shape by transparent resin such as polycarbonate resin, acrylic resin, polyolefin resin, PET (polyethylene terephthalate) resin, etc. A convex pattern 42 formed in an isosceles trapezoidal shape in section is mutually spaced and formed on the face of a side opposed to the light incident face 47. A light reflecting area 43a and a light transmitting area 43b are formed on the upper face of the semi-transmitting reflection sheet 19. The light reflecting area 43a is formed by a reflection wall 44 and a reflection wall 45 of the convex pattern 42 having an inclination angle of 45°. Further, the light transmitting area 43b is an area parallel to the light incident face 47, and is constructed by a flat area outside the convex pattern 42, and a flat area within the convex pattern 42.

As shown in FIG. 18, the reflection wall 44 and the reflection wall 45 included in the single convex pattern 42 are separated with the light transmitting area 43b between. Namely, the light transmitting area 43b is divided into a flat area (the light transmitting area 43b outside the convex pattern 42) connected to lower ends of the reflection walls 44, 45, and a flat area (the light transmitting area 43b within the convex pattern 42) connected to upper ends of the reflection walls 44, 45 and located in a high position raised by one stage. Further, the reflection walls 44, 45 are respectively inclined in opposite directions on a slanting face of 45° with respect to the light transmitting area 43b. Namely, the reflection walls 44, 45 are orthogonal.

Light 41 approximately perpendicularly emitted from the light emitting face 37 of the light guide plate 21 is approximately perpendicularly incident from the lower face of the semi-transmitting reflection sheet 19 into the semi-transmitting reflection sheet 19, and reaches the light reflecting area 43a and the light transmitting area 43b. Light 41 reaching the light transmitting area 43b is approximately perpendicularly emitted from the light transmitting area 43b. On the other hand, light 41 reaching the light reflecting area 43a is totally reflected on one reflection wall 44, and is advanced in parallel with the light transmitting area 43b, and is totally reflected on the other reflection wall 45, and is approximately perpendicularly emitted from the lower face of the semi-transmitting reflection sheet 19.

When the liquid crystal panel 16 is illuminated through such a semi-transmitting reflection sheet 19, the reflection wall 44 and the reflection wall 45 of the light reflecting area 43a are separately arranged so that it does not become easy to recognize an area for reflecting light on the light reflecting area 43a and emitting this light onto the liquid crystal panel 18 side, and an area for transmitting light through the light transmitting area 43b and emitting this light onto the liquid crystal panel 16 side. Accordingly, brightness of light on the light transmitting side and the light reflecting side of the semi-transmitting reflection sheet 19 can be uniformed, and no irregularities of lightness are easily caused.

### EMBODIMENT 4

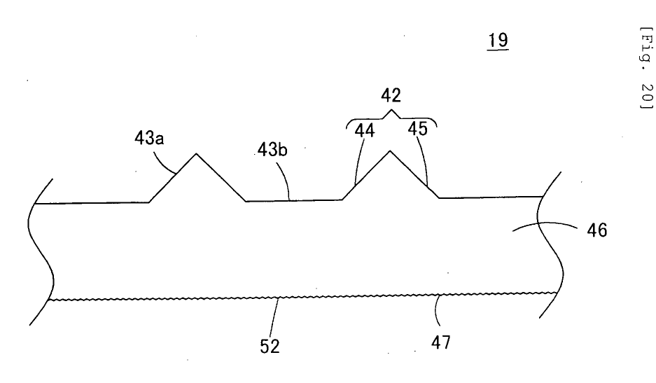

In embodiment 4 of the present invention, the structure of the semi-transmitting reflection sheet 19 in embodiment 1 is changed. FIG. 19 is a cross-sectional view of the semi-transmitting reflection sheet 19 in embodiment 4. In this semi-transmitting reflection sheet 19, a scattering face 52 for scattering light is formed in the light transmitting area 43b among a face of the side opposed to the light incident face 47. For example, irregularities sufficiently finer than the convex pattern 42 are formed at random as the scattering face 52.

In accordance with such an embodiment, for example, there is a case in which a diffusion sheet for scattering light between the liquid crystal panel 16 and the semi-transmitting reflection sheet 19 is arranged in the both-face image display device 15 shown in FIG. 3 of this embodiment 1 to widen the directivity of light irradiated to the liquid crystal panel 16. However, no diffusion sheet is required when the semi-transmitting reflection sheet 19 having a light diffusion function as in this embodiment is used.

### EMBODIMENT 5

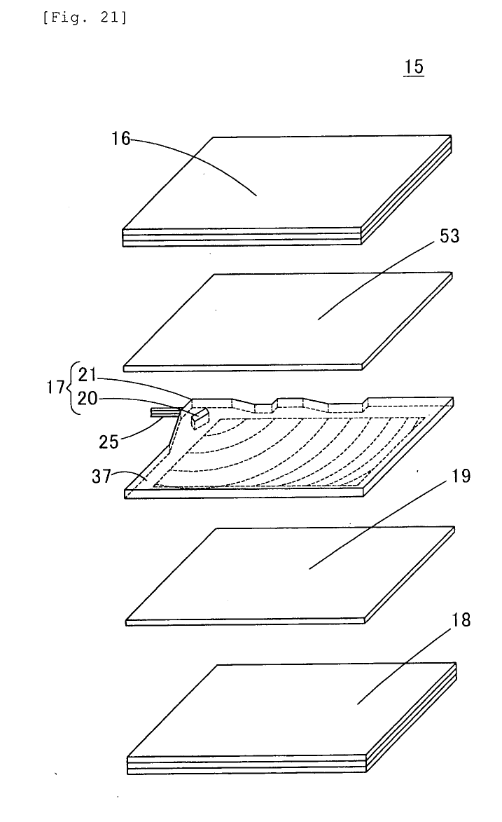

In embodiment 5 of the present invention, the structure of the semi-transmitting reflection sheet 19 in embodiment 1 is changed. FIG. 20 is a cross-sectional view of the semi-transmitting reflection sheet 19 in embodiment 5. In this embodiment, a scattering face 52 for scattering light is formed on the entire light incident face 47 of the semi-transmitting reflection sheet 19 or one portion of the light incident face 47.

For example, there is a case in which a diffusion sheet for scattering light between the liquid crystal panel 18 and the semi-transmitting reflection sheet 19 is arranged in the both-face image display device 15 show in FIG. 3 of embodiment 1 to widen the directivity of light irradiated to the liquid crystal panel 18. However, no diffusion sheet is required when the semi-transmitting reflection sheet 19 having a light diffusion function as in this embodiment is used. Further, when the lower face of the semi-transmitting reflection sheet 19 is flat as in the both-face image display device 15 shown in FIG. 3 of embodiment 1, there is a case in which the light guide plate 21 and the semi-transmitting reflection sheet 19 are closely attached, and brightness irregularities are generated. However, if the semi-transmitting reflection sheet 19 for setting a face opposed to the liquid crystal panel 18 to the scattering face 52 is used as in this embodiment, it is possible to prevent the brightness irregularities due to the close attachment generated between the light guide plate 21 and the semi-transmitting reflection sheet 19.

### EMBODIMENT 6

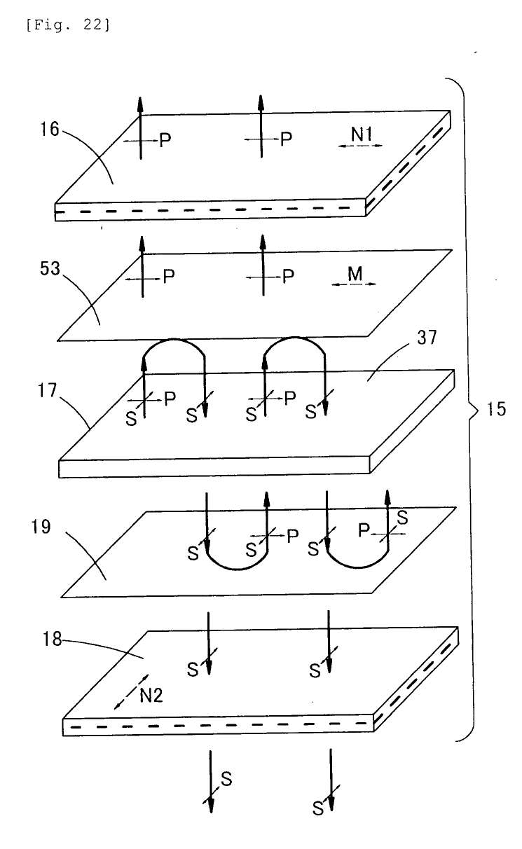

FIG. 21 is an exploded perspective view of a both-face image display device 15 in embodiment 6 of the present invention. This both-face image display device 15 is constructed from a first liquid crystal panel 16, a surface light source device 17, a second liquid crystal panel 18, a semi-transmitting reflection sheet 19 and a polarizing selection reflection sheet 53. The polarizing selection reflection sheet 53 is arranged so as to be opposed to one face of the surface light source device 17 (the face of an arranging side of the polarizing selection reflection sheet 53 is set to an upper face side in accordance with FIG. 21). The semi-transmitting reflection sheet 19 is arranged so as to be opposed to the other face of the surface light source device 17 (the face of an arranging side of the semi-transmitting reflection sheet 19 is set to a lower face side in accordance with FIG. 21). Further, the first liquid crystal panel 16 is arranged so as to be opposed to the upper face side of the polarizing selection reflection sheet 53. The second liquid crystal panel 18 is arranged so as to be opposed to the lower face side of the semi-transmitting reflection sheet 19. Further, the surface light source device 17 is constructed by a light source 20 and a light guide plate 21.

The polarizing selection reflection sheet 53 has an area larger than pixel forming areas of the liquid crystal panels 16, 18. The polarizing selection reflection sheet 53 transmits light of one polarizing state among incident light, and reflects light of the other polarizing state. Such a polarizing selection reflection sheet 53 transmits linearly polarized light of one polarizing direction among the incident light, and reflects linearly polarized light of a polarizing direction orthogonal to this one polarizing direction. For example, there is D-BEF (article name) manufactured by Sumitomo Three M Co., Ltd. as such a polarizing selection reflection sheet 53. Further, for example, there is NIPOCS-PCF (article name) manufactured by Nitto Denko Co., Ltd. as a polarizing selection reflection sheet for transmitting circularly polarized light or elliptically polarized light of one turning direction among the incident light, and reflecting circularly polarized light or elliptically polarized light of the turning direction of an opposite direction. In the following explanation, the polarizing selection reflection sheet 53 is set to be arranged so as to transmit one linearly polarized light (which is called P-polarized light), and reflect the other linearly polarized light (which is called S-polarized light).

As shown in FIG. 22, the liquid crystal panel 16 is arranged above the polarizing selection reflection sheet 53 such that its polarizing transmission axis N1 is parallel to the direction of a polarizing transmission axis M of the polarizing selection reflection sheet 53. Similarly, the liquid crystal panel 18 is arranged below the semi-transmitting reflection sheet 19 such that its polarizing transmission axis N2 is perpendicular to the polarizing transmission axis M of the polarizing selection reflection sheet 53. In this embodiment, the liquid crystal panel 16 is arranged so as to transmit the P-polarized light, and the liquid crystal panel 18 is arranged so as to transmit the S-polarized light. The liquid crystal panels 16, 18 are of a transmission type or a semi-transmission type.

The behavior of light emitted from the surface light source device 17 in this both-face image display device 15 will be explained by FIG. 22. As shown in FIG. 22, light approximately perpendicularly emitted from the light emitting face 37 of the surface light source device 17 is incident to the polarizing selection reflection sheet 53. Here, light emitted from the surface light source device 17 has the P-polarized light and the S-polarized light. The P-polarized light among light incident to the polarizing selection reflection sheet 53 is transmitted through the polarizing selection reflection sheet 53, and the S-polarized light is reflected on the polarizing selection reflection sheet 53. Since the polarizing transmission axis N1 of the liquid crystal panel 16 is arranged so as to transmit the P-polarized light, the P-polarized light transmitted through the polarizing selection reflection sheet 53 is transmitted through the liquid crystal panel 16, and generates an image of the liquid crystal panel 16.

Further, the S-polarized light reflected on the polarizing selection reflection sheet 53 passes the surface light source device 17, and is incident to the semi-transmitting reflection sheet 19. The S-polarized light reaching the light transmitting area 43b among the S-polarized light incident to the semi-transmitting reflection sheet 19 is transmitted through the semi-transmitting reflection sheet 19, and the S-polarized light reaching the light reflecting area 43a is reflected on the reflection walls 44 and 45. Since the polarizing transmission axis N2 of the liquid crystal panel 18 is arranged so as to transmit the S-polarized light, the S-polarized light transmitted through the light transmitting area 43b of the semi-transmitting reflection sheet 19 is transmitted through the liquid crystal panel 18, and generates an image of the liquid crystal panel 18.

On the other hand, with respect to light reflected on the light reflecting area 43a of the semi-transmitting reflection sheet 19, the polarizing direction of the light is turned when this light is reflected on the light reflecting area 43a. Accordingly, this light becomes light in which the P-polarized light and the S-polarized light are mixed. The light reflected on the light reflecting area 43a of the semi-transmitting reflection sheet 19 is transmitted through the surface light source device 17, and is again incident to the polarizing selection reflection sheet 53. The P-polarized light among the light incident to the polarizing selection reflection sheet 53 is transmitted through the polarizing selection reflection sheet 53, and generates an image of the liquid crystal panel 16. The S-polarized light among the light incident to the polarizing selection reflection sheet 53 is reflected on the polarizing selection reflection sheet 53, and is again incident to the semi-transmitting reflection sheet 19. One portion of the S-polarized light incident to the semi-transmitting reflection sheet 19 is transmitted through the semi-transmitting reflection sheet 19, and generates an image of the liquid crystal panel 18.

Further, another portion of the S-polarized light is reflected on the semi-transmitting reflection sheet 19, and is turned, and becomes mixing light of the P-polarized light and the S-polarized light, and is again incident to the polarizing selection reflection sheet 53. Thus, light emitted from the light guide plate 21 repeats reflection and rotation of the polarizing axis between the polarizing selection reflection sheet 53 and the semi-transmitting reflection sheet 19, and is used without uselessness in the image generation of the liquid crystal panel 16 and the image generation of the liquid crystal panel 18.

In accordance with the both-face image display device 15 of this embodiment, since the two liquid crystal panels 16, 18 can be simultaneously illuminated by one surface light source device 17, the both-face image display device 15 can be thinly made, and electric power can be saved. Further, since no light emitted from the surface light source device 17 is absorbed in the light reflecting area 43a of the semi-transmitting reflection sheet 19, light emitted from the light source 20 can be almost utilized without loss, and it is excellent in utilization efficiency of light.

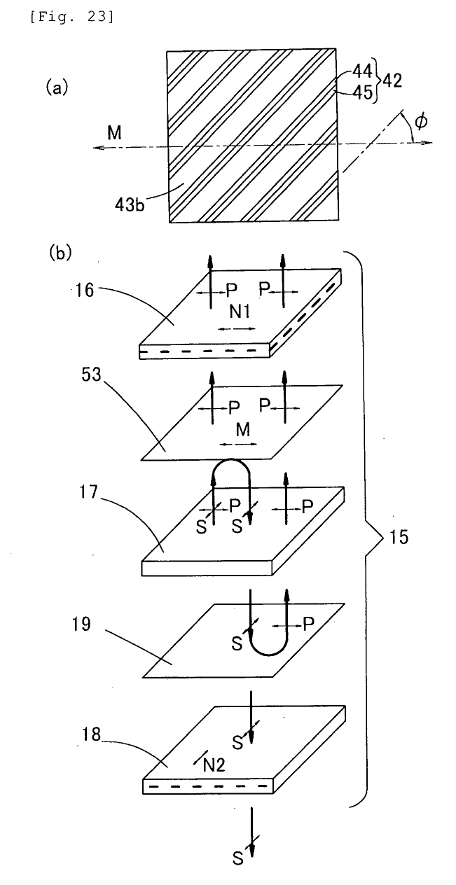

Here, as shown in FIG. 23, if the light reflecting area 43a and the light transmitting area 43b formed in the semi-transmitting reflection sheet 19 are arranged so as to be rotated by φ=45° or φ=135° with respect to the polarizing axis M of the polarizing selection reflection sheet 53 in the both-face image display device 15 of this embodiment, the polarizing direction of light is turned 45° every reflection on the reflection wall 44 or 45. Namely, since light incident to the light reflecting area 43a of the semi-transmitting reflection sheet 19 is reflected twice on the reflection walls 44 and 45, the polarizing direction of light reflected on the semi-transmitting reflection sheet 19 and emitted is turned 90° with respect to the light incident to the semi-transmitting reflection sheet 19.

Accordingly, in the both-face image display device 15 of this embodiment, the S-polarized light incident to the light reflecting area 43a of the semi-transmitting reflection sheet 19 becomes P-polarized light and is reflected. Namely, if it is used in the both-face image display device 15, the P-polarized light among light emitted from the surface light source device 17 is transmitted through the polarizing selection reflection sheet 53, and generates an image of the liquid crystal panel 16. On the other hand, the S-polarized light is reflected on the polarizing selection reflection sheet 53, and reaches the semi-transmitting reflection sheet 19. One portion of the S-polarized light reaching the semi-transmitting reflection sheet 19 is transmitted through the semi-transmitting reflection sheet 19, and generates an image of the liquid crystal panel 18. The remaining one portion is reflected on the semi-transmitting reflection sheet 19, and the polarizing direction of the light is rotated 90°, and this light becomes P-polarized light, and is transmitted through the polarizing selection reflection sheet 53, and generates an image of the liquid crystal panel 16.

Thus, in comparison with a case in which the polarizing axis M of the polarizing selection reflection sheet 53 and the arrangement of the light reflecting area 43a and the light transmitting area 43b formed in the semi-transmitting reflection sheet 19 are not considered, the number of reflection times of light between the polarizing selection reflection sheet 53 and the semi-transmitting reflection sheet 19 is reduced so that the liquid crystal panel can be more efficiently illuminated.

### EMBODIMENT 7

Light is not necessarily emitted in only the perpendicular direction from the light guide plate 21 of the surface light source device 17, but leak light emitted toward a slanting direction from the light emitting face 37 and a face of its opposite side exists. For example, there are a case in which light leaked from the deflection inclination face 39 of the deflecting pattern 36 arranged in the light guide plate 21 to the exterior is not incident to the re-incident face 40, but is slantingly emitted, etc. Such leak light is not utilized in illumination of the liquid crystal panel, and becomes useless. Therefore, the semi-transmitting reflection sheet 19 of embodiment 7 of the present invention proposes a structure able to efficiently utilize this leak light.

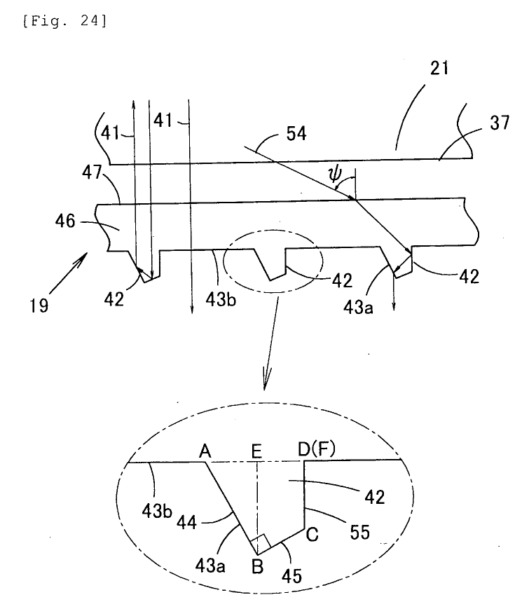

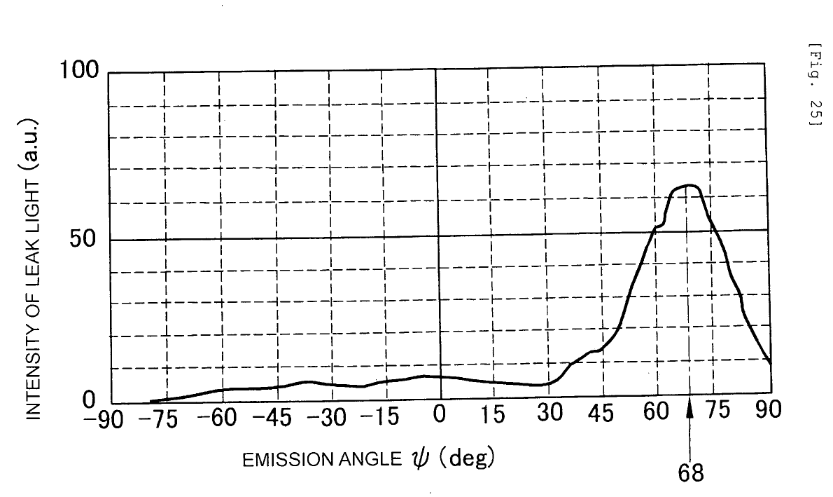

FIG. 24 shows a cross-sectional view of the semi-transmitting reflection sheet 19. A light reflecting area 43a and a light transmitting area 43b are formed on the lower face (a face of the side opposed to the light incident face 47) of the semi-transmitting reflection sheet 19. The light transmitting area 43b is constructed by a flat face parallel to the light incident face 47 of the semi-transmitting reflection sheet 19. On the other hand, the light reflecting area 43a is constructed by a convex pattern 42 having a square sectional shape. FIG. 24 shows a section perpendicular to the longitudinal direction of the convex pattern 42, and perpendicular to the light incident face 47. The sectional shape of the convex pattern 42 has four vertexes A, B, C, D, and the vertical angle of vertex B is set to an angle of 90°. Side AB and side BC for nipping vertex B respectively become the reflection wall 44 and the reflection wall 45. Side CD for connecting vertex C and vertex D becomes a leak light reflection wall 55, and becomes a face approximately perpendicular to the light incident face 47. Further, an intersection point of a perpendicular line perpendicularly drawn from vertex B to the light incident face 47, and a plane conformed to the light transmitting area 43b is set to E. An intersection point of a perpendicular line perpendicularly drawn from vertex C to the light incident face 47, and the plane conformed to the light transmitting area 43b is set to F. At this time, projection length AE of side AB and projection length EF of side BC become equal. In FIG. 24, since side CD (leak light reflection wall 55) becomes a face perpendicular to the light incident face 47, vertex D and point F are overlapped.

In this embodiment, partial light 41 among light 41 perpendicularly incident to the light incident face 47 of the semi-transmitting reflection sheet 19 is transmitted through the light transmitting area 43b, and is emitted from a face of the side opposed to the light incident face 47. The remaining partial light 41 is incident to the reflection wall 44 or the reflection wall 45 of the convex pattern 42, and is regressively reflected on the reflection walls 44, 45, and is returned in the original direction, and is emitted in a direction opposed to the incident direction from the light incident face 47.

Further, leak light 54 slantingly emitted from the light guide plate 21 is slantingly incident from the light incident face 47 into the semi-transmitting reflection sheet 19. Light slantingly incident and incident to the leak light reflection wall 55 is totally reflected on the leak light reflection wall 55, and is then incident to the reflection wall 44, and is refracted in the reflection wall 44, and is emitted from the reflection wall 44 to the exterior. Here, an angle φ of the leak light 54 is supposed to a certain angle, and the inclination of the leak light reflection wall 55 is set to an appropriate angle with respect to this angle φ. Thus, the direction of the leak light 54 refracted in the reflection wall 44 and emitted is set to be directed to a direction perpendicular to the light incident face 47.

Thus, since the leak light 54 from the light guide plate 21 can be also used in the illumination of the liquid crystal panel in the semi-transmitting reflection sheet 19 of this embodiment, light from the light source 20 can be more efficiently used.

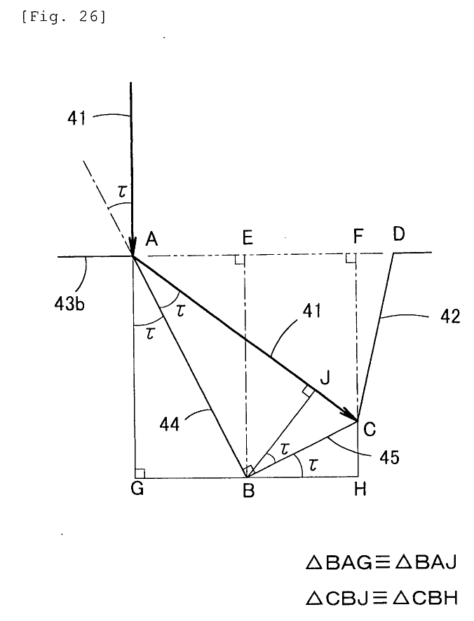

The leak light 54 from the light guide plate 21 used in the both-face image display device 15 of this embodiment has a peak in a direction inclined by φ=≅68° from the direction perpendicular to the pattern face 38 of the light guide plate 21 as in a measuring result shown in FIG. 25. The shape of the convex pattern 42 shown in this embodiment is designed such that the leak light 54 emitted in this φ≅68° direction is emitted in the perpendicular direction and can be efficiently utilized. When the emitting direction of the leak light 54 is changed, the shape of the convex pattern 42 is also naturally changed in conformity with this change.

Further, in this embodiment, projection length AE and projection length EF are set to be equal. When these projection lengths AE and EF are equally set, light totally reflected on the entire face of the reflection wall 44 is spread on the entire face of the reflection wall 45 and is incident. Conversely, light totally reflected on the entire face of the reflection wall 45 is spread on the entire face of the reflection wall 44 and is incident. Light reflected on one of the reflection walls 44, 45 is not reflected on the other of the reflection walls 45, 44 and is not emitted in a slanting direction. Further, no useless area is generated in the reflection walls 44, 45, and the micro convex pattern 42 able to efficiently reflect light can be manufactured at a size having no uselessness.

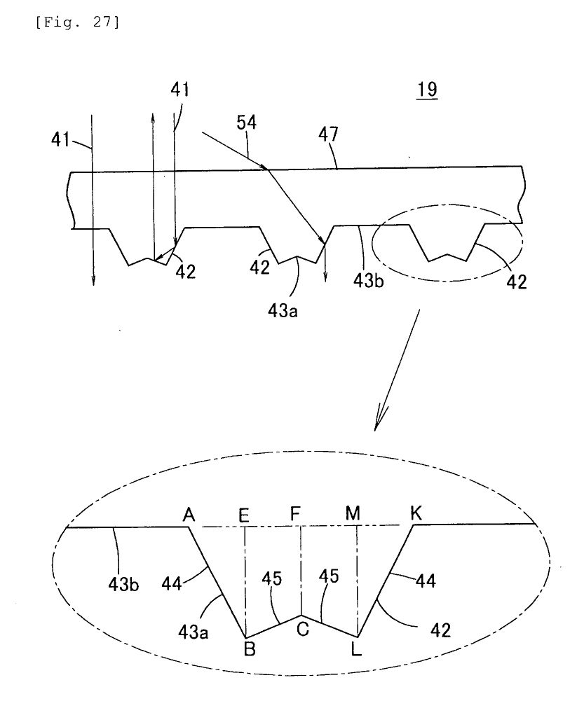

FIG. 26 is a view for explaining this reason. In FIG. 26, point E is an intersection point of a perpendicular line perpendicularly drawn from vertex B to the light incident face 47 and a plane conformed to the light transmitting area 43b. Point F is an intersection point of a perpendicular line perpendicularly drawn from vertex C to the light incident face 47 and the plane conformed to the light transmitting area 43b. In FIG. 24, side CD (leak light reflection wall 55) is perpendicular to the light transmitting area 43b, and point F and point D are conformed. However, FIG. 26 shows a case in which side CD is slightly inclined to distinguish point F and point D.

Further, an intersection point of a straight line passing vertex A and perpendicular to the light transmitting area 43b and a straight line passing vertex B and parallel to the light transmitting area 43b is set to G. An intersection point of a straight line passing vertex C and perpendicular to the light transmitting area 43b and a straight line passing vertex B and parallel to the light transmitting area 43b is set to H. Further, the foot of a perpendicular line drawn from vertex B to line segment AC is set to J.

We now consider a case in which, when light 41 is incident perpendicularly to the light transmitting area 43b from the upper direction of FIG. 26, all light beams reflected on side AB (reflection wall 44) are incident to side BC (reflection wall 45), and a light beam reflected on side AB is spread on the entire side BC. Therefore, it is understood that it is sufficient to set light incident to vertex A of an end of side AB and reflected on side AB so as to be incident to vertex C as in light 41 shown in FIG. 26.

When the inclination of side AB measured from perpendicular line AG is set to ∠BAG=τ, light 41 perpendicularly incident to vertex A is incident in an inclination of τ with respect to side AB. Accordingly, light 41 reflected on side AB is also emitted in the inclination of τ with respect to side AB. Namely, ∠BAG=τ is formed. Accordingly, it is understood that a right-angled triangle BAG having one vertical angle of τ and a right-angled triangle BAJ having one vertical angle of τ are congruent and

length GB=length JB (1)

is formed.

It can be also easily confirmed that angle CBJ=τ and angle CBH=τ are formed. Accordingly, it is understood that a right-angled triangle CBJ having one vertical angle of τ and a right-angled triangle CBH having one vertical angle of τ are congruent and

length BJ=length BH (2)

is formed.

Accordingly,

length GB=length BH (3)

is obtained from formulas (1) and (2). Since length GB=length AE, and length BH=length EF are clearly formed, it is understood that it is sufficient to form the following formula (4) so as to finally set a light beam incident to side AB to be entirely spread and incident on side BC.

projection length AE of side AB=projection length EF of side BC (4)

Similarly, in accordance with the principle of retrogression of light, it is also understood that a condition in which all light beams incident from the perpendicular upward direction and reflected on side BC (reflection wall 45) are incident to side AB (reflection wall 44), and the light beam reflected on side BC is entirely spread on side AB is also given by the above formula (4).

### EMBODIMENT 8

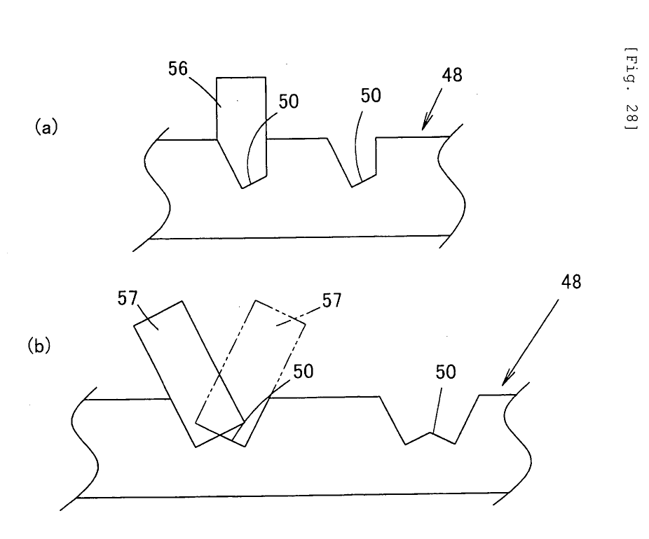

In embodiment 8 of the present invention, embodiment 7 is further modified. FIG. 27 is a cross-sectional view of the semi-transmitting reflection sheet 19. A light reflecting area 43a and a light transmitting area 43b are formed on a face of the side opposed to the light incident face 47 of the semi-transmitting reflection sheet 19. The light transmitting area 43b is constructed by a flat face parallel to the light incident face 47 of the semi-transmitting reflection sheet 19. On the other hand, the light reflecting area 43a is constructed by a convex pattern 42 having a pentagonal shape of a W-character shape in section. As shown in FIG. 27, when vertexes of the convex pattern 42 are shown by A, B, C, L, K, each of the vertical angles of vertex B and vertex L is set to 90°, and side AB and side KL become a reflection wall 44, and side BC and side CL become a reflection wall 45. An intersection point of a perpendicular line perpendicularly drawn from vertex B to the light incident face 47 and a plane conformed to the light transmitting area 43b is set to E. An intersection point of a perpendicular line perpendicularly drawn from vertex C to the light incident face 47 and the plane conformed to the light transmitting area 43b is set to F. An intersection line of a perpendicular line perpendicularly drawn from vertex L to the light incident face 47 and the plane conformed to the light transmitting area 43b is set to M. At this time, projection length AE of side AB, and projection length EF of side BC are equal to each other. Further, projection length FM of side CL and projection length MK of side LK are equal to each other. In FIG. 27, the sectional shape of the convex pattern 42 is a left-right symmetrical shape, but may not be the left-right symmetrical shape if the above condition is satisfied.

In this embodiment, as shown in FIG. 27, partial light 41 among light 41 incident to the semi-transmitting reflection sheet 19 reaches the light transmitting area 43b, and is emitted from the face of the side opposed to the light incident face 47 of the semi-transmitting reflection sheet 19. The remaining partial light 41 is totally reflected on reflection walls 44, 45 of the convex pattern 42, and is emitted in a direction reverse to a direction incident from the light incident face 47 of the semi-transmitting reflection sheet 19.

Further, leak light 54 emitted in a slanting direction from the light guide plate 21 is incident from the light incident face 47 into the semi-transmitting reflection sheet 19. Light incident to the reflection wall 44 among the leak light 54 is not totally reflected on the reflection wall 44, but is transmitted through the reflection wall 44, and is refracted at that time. The leak light 54 refracted in the reflection wall 44 and emitted to the exterior is emitted toward a direction approximately perpendicular to the light incident face 47. It is sufficient to design an inclination angle of the reflection wall 44 in accordance with the incident direction of the leak light 54 so as to achieve such an optical behavior.

Thus, since the leak light 54 from the light guide plate 21 can be also used in the illumination of the liquid crystal panel in the semi-transmitting reflection sheet 19 of this embodiment, light from the light source 20 can be more efficiently used.

Further, since projection length AE and projection length EF are also set to be equal in this embodiment, light totally reflected on the entire face of the reflection wall 44 (side AB) is spread and incident on the entire face of the reflection wall 45 (side BC). Conversely, light totally reflected on the entire face of the reflection wall 45 (side BC) is spread and incident on the entire face of the reflection wall 44 (side AB). Similarly, since projection length FM and projection length MK are equal, light totally reflected on the entire face of the reflection wall 44 (side LK) is spread and incident on the entire face of the reflection wall 45 (side CL). Conversely, light totally reflected on the entire face of the reflection wall 45 (side CL) is spread and incident on the entire face of the reflection wall 44 (side LK). Accordingly, no useless area is generated in the reflection walls 44, 45, and the micro convex pattern 42 able to efficiently reflect light can be manufactured at a size having no uselessness.

Further, the convex pattern 42 of this embodiment is set to a sectional shape easily detached from a die at a molding time in comparison with the convex pattern 42 of the semi-transmitting reflection sheet 19 shown in embodiment 7.

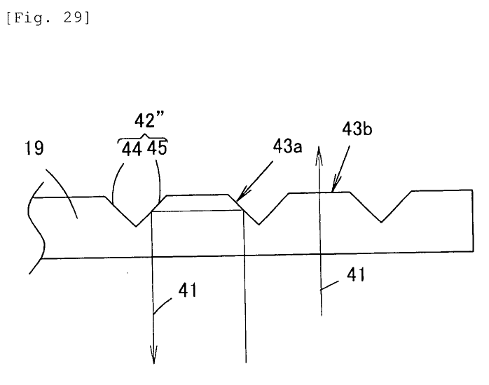

Further, the semi-transmitting reflection sheet 19 is manufactured by using a molding die as explained by FIGS. 10(a) to 10(c). In an upper die 48, a concave stripe 50 for molding the convex pattern 42 is arranged by performing grinding processing using a cutting tool. Here, when the semi-transmitting reflection sheet 19 of embodiment 7 is manufactured, the section of the concave stripe 50 of the upper die 48 is formed in a deformed square shape. Accordingly, as shown in FIG. 28(a), a cutting tool 56 of a special shape is required to grind and process this concave stripe 50.

In contrast to this, in the upper die 48 for molding the convex pattern 42 of this embodiment, as shown in FIG. 28(b), the concave stripe 50 of a W-character shape in section widened in width on an opening side is required. Furthermore, the angles of corner portions of both sides located in a lowest position of this concave stripe 50 of the W-character shape become 90°. Accordingly, if it is intended to grind and process the concave stripe 50 of such a shape in the upper die 48, as shown in FIG. 28(b), a cutting tool 57 formed in a simple shape of a rectangular shape is prepared. If the grinding processing is performed twice by changing an inclination of the cutting tool 57 and conforming a corner of the cutting tool 57 to the corner portions of two places of 90°, the concave stripe 50 can be easily processed by using the cutting tool of a simple shape.

### EMBODIMENT 9

FIG. 29 is a partial enlarged sectional view showing a semi-transmitting reflection sheet 19 in accordance with embodiment 9 of the present invention. In embodiment 9, a light reflecting area 43a of the semi-transmitting reflection sheet 19 is constructed by plural concave patterns 42″ formed in a V-groove shape (claim 6). The concave pattern 42″ is constructed by a reflection wall 44 and a reflection wall 45 mutually orthogonal. The concave pattern 42″ is mutually spaced and is arranged in parallel.

In such a semi-transmitting reflection sheet 19, a flat area formed between the concave patterns 42″ becomes a light transmitting area 43b, and light 41 incident here is transmitted through the semi-transmitting reflection sheet 19. Further, light 41 incident to the reflection wall 44 or 45 as the light reflecting area 43a is reflected on the reflection wall 44 and the reflection wall 45 between the adjacent concave patterns 42″, and is regressively reflected toward the original direction.

In each of the above embodiments, the optical sheet of the present invention has been explained in relation to the surface light source device or the liquid crystal display device. However, no use of the optical sheet of the present invention is limited to the surface light source device and the liquid crystal display device.

1. An optical sheet in which plural convex patterns having at least two inclining reflection walls are mutually spaced and formed on a face opposed to a light incident face of a transparent substrate with one face as the light incident face; and
one portion of light incident to said transparent substrate is totally reflected on each reflection wall of said convex pattern and is thereby emitted from the light incident face toward a direction parallel to an incident direction; and the remaining one portion of the light incident to said transparent substrate is transmitted through an area not forming said reflection wall and is thereby emitted from a face opposed to the light incident face.

2. The optical sheet according to claim 1, wherein a sectional shape of said convex pattern in a certain section perpendicular to the light incident face of said transparent substrate is an equilateral triangle in which two reflection faces constituting said convex pattern forms an angle of about 90 degrees.

3. The optical sheet according to claim 1, wherein a sectional shape of said convex pattern in a certain section perpendicular to the light incident face of said transparent substrate is an isosceles trapezoidal shape having an inclination angle of said reflection wall of about 45 degrees.

4. The optical sheet according to claim 1, wherein a sectional shape of said convex pattern in a certain section perpendicular to the light incident face of said transparent substrate is a square shape in which the vertical angle of a vertex located in a farthest position from said light incident face is about 90 degrees, and the projection lengths of two sides nipping this vertex onto said light incident face are approximately equal.

5. The optical sheet according to claim 1, wherein a sectional shape of said convex pattern in a certain section perpendicular to the light incident face of said transparent substrate is a pentagonal shape of an about W-character shape hollow in its central portion such that each of the vertical angles of two vertexes projected toward a side far from the light incident face of the convex pattern is 90 degrees, and each of the projection lengths of two sides nipping these vertexes onto said light incident face is approximately equal.

6. The optical sheet according to claim 1, wherein a light diffusion face is formed in at least one portion of a face not forming said reflection wall among the light incident face of said transparent substrate and a face opposed to the light incident face.

7. An optical sheet in which plural concave patterns having at least two inclining reflection walls are mutually spaced and formed on a face opposed to a light incident face of a transparent substrate with one face as the light incident face; and
one portion of light incident to said transparent substrate is totally reflected on the reflection wall between said concave patterns and is thereby emitted from the light incident face toward a direction parallel to an incident direction; and the remaining one portion of the light incident to said transparent substrate is transmitted through an area not forming said reflection wall and is thereby emitted from a face opposed to the light incident face.

8. The optical sheet according to claim 7, wherein a sectional shape of said concave pattern in a certain section perpendicular to the light incident face of said transparent substrate is a V-groove shape of an equilateral triangle in which two reflection walls constituting said concave pattern forms an angle of about 90 degrees.

9. The optical sheet according to claim 7, wherein a sectional shape of said concave pattern in a certain section perpendicular to the light incident face of said transparent substrate is a concave groove shape of an isosceles trapezoidal shape having an inclination angle of said reflection wall of about 45 degrees.

10. The optical sheet according to claim 7, wherein a light diffusion face is formed in at least one portion of a face not forming said reflection wall among the light incident face of said transparent substrate and a face opposed to the light incident face.

11. An optical sheet in which plural irregular patterns of concave and convex shapes having at least three inclining reflection walls are mutually spaced and formed on a face opposed to a light incident face of a transparent substrate with one face as the light incident face; and
one portion of light incident to said transparent substrate is totally reflected on the reflection wall between said irregular patterns and is thereby emitted from the light incident face toward a direction parallel to an incident direction; and the remaining one portion of the light incident to said transparent substrate is transmitted through an area not forming said reflection wall and is thereby emitted from a face opposed to the light incident face.

12. The optical sheet according to claim 11, wherein a light diffusion face is formed in at least one portion of a face not forming said reflection wall among the light incident face of said transparent substrate and a face opposed to the light incident face.

13. A surface light source device constructed by a light source, and a light guide plate for spreading light incident from the light source in a face shape and emitting this light from a light emitting face; and
the optical sheet according to claim 1 is arranged on a light emitting face side of said light guide plate so as to direct its light incident face toward said light guide plate so that light is emitted on the light emitting face side of said light guide plate and a side opposed to the light emitting face.

14. A surface light source device constructed by a light source, and a light guide plate for spreading light incident from the light source in a face shape and emitting this light from a light emitting face; and
a polarizing selection reflection sheet is arranged on a light emitting face side of said light guide plate, and the optical sheet according to claim 1 is arranged on a side opposed to the light emitting face of said light guide plate so as to direct its light incident face toward said light guide plate so that light is emitted on the light emitting face side of said light guide plate and the side opposed to the light emitting face.

15. A surface light source device constructed by a light source, and a light guide plate for spreading light incident from the light source in a face shape and emitting this light from a light emitting face; and
a polarizing selection reflection sheet is arranged on a light emitting face side of said light guide plate, and the optical sheet according to claim 4 is arranged on a side opposed to the light emitting face of said light guide plate so as to direct its light incident face toward said light guide plate so that light is emitted on the light emitting face side of said light guide plate and the side opposed to the light emitting face; and
light emitted from a face opposed to the light emitting face of said light guide plate is reflected or refracted by a convex pattern of said optical sheet so that this light is deflected in the same direction as light transmitted through an area forming no convex pattern of the optical sheet, and is emitted from the face opposed to the light incident face of said optical sheet.

16. The surface light source device according to claim 14, wherein a convex, concave or irregular pattern of said optical sheet is formed in a straight line shape seen from the light incident face side of the optical sheet, and a direction for extending the convex, concave or irregular pattern in the straight line shape and a polarizing axis direction of said polarizing selection reflection sheet form an angle of about 45 degrees.

17. The surface light source device according to claim 15, wherein a convex, concave or irregular pattern of said optical sheet is formed in a straight line shape seen from the light incident face side of the optical sheet, and a direction for extending the convex, concave or irregular pattern in the straight line shape and a polarizing axis direction of said polarizing selection reflection sheet form an angle of about 45 degrees.

18. A surface light source device constructed by a light source, and a light guide plate for spreading light incident from the light source in a face shape and emitting this light from a light emitting face; and
the optical sheet according to claim 7 is arranged on a light emitting face side of said light guide plate so as to direct its light incident face toward said light guide plate so that light is emitted on the light emitting face side of said light guide plate and a side opposed to the light emitting face.

19. A surface light source device constructed by a light source, and a light guide plate for spreading light incident from the light source in a face shape and emitting this light from a light emitting face; and
the optical sheet according to claim 11 is arranged on a light emitting face side of said light guide plate so as to direct its light incident face toward said light guide plate so that light is emitted on the light emitting face side of said light guide plate and a side opposed to the light emitting face.

20. A surface light source device constructed by a light source, and a light guide plate for spreading light incident from the light source in a face shape and emitting this light from a light emitting face; and
a polarizing selection reflection sheet is arranged on a light emitting face side of said light guide plate, and the optical sheet according to claim 7 is arranged on a side opposed to the light emitting face of said light guide plate so as to direct its light incident face toward said light guide plate so that light is emitted on the light emitting face side of said light guide plate and the side opposed to the light emitting face.

21. A surface light source device constructed by a light source, and a light guide plate for spreading light incident from the light source in a face shape and emitting this light from a light emitting face; and
a polarizing selection reflection sheet is arranged on a light emitting face side of said light guide plate, and the optical sheet according to claim 11 is arranged on a side opposed to the light emitting face of said light guide plate so as to direct its light incident face toward said light guide plate so that light is emitted on the light emitting face side of said light guide plate and the side opposed to the light emitting face.

22. A surface light source device constructed by a light source, and a light guide plate for spreading light incident from the light source in a face shape and emitting this light from a light emitting face; and
a polarizing selection reflection sheet is arranged on a light emitting face side of said light guide plate, and the optical sheet according to claim 5 is arranged on a side opposed to the light emitting face of said light guide plate so as to direct its light incident face toward said light guide plate so that light is emitted on the light emitting face side of said light guide plate and the side opposed to the light emitting face; and
light emitted from a face opposed to the light emitting face of said light guide plate is reflected or refracted by a convex pattern of said optical sheet so that this light is deflected in the same direction as light transmitted through an area forming no convex pattern of the optical sheet, and is emitted from the face opposed to the light incident face of said optical sheet.
